(19) United States
(12) Patent Application Publication
(10) Pub. No.: US 2023/0177345 A1
(43) Pub. Date: Jun. 8, 2023

(54) METHODS AND SYSTEMS THAT USE MACHINE-LEARNING TO DETERMINE WORKLOADS AND TO EVALUATE DEPLOYMENT/CONFIGURATION POLICIES

(71) Applicant: VMware, Inc., Palo Alto, CA (US)

(72) Inventors: Marius Vilcu, Arlington, MA (US); Dongni Wang, Palo Alto, CA (US); Asmitha Rathis, Palo Alto, CA (US); Greg Burk, Colorado Springs, CO (US)

(73) Assignee: VMware, Inc., Palo Alto, CA (US)

(21) Appl. No.: 17/545,403

(22) Filed: Dec. 8, 2021

(51) Int. Cl. G06N 3/08; G06N 3/04; G06F 9/50

(52) U.S. Cl. CPC G06N 3/088; G06N 3/04; G06F 9/505

(57) ABSTRACT

The current document is directed to methods and systems that determine workload characteristics of computational entities from stored data and that evaluate deployment/configuration policies in order to facilitate deploying, launching, and controlling distributed applications, distributed-application components, and other computational entities within distributed computer systems. Deployment/configuration policies are powerful tools for assisting managers and administrators of distributed applications and distributed computer systems, but constructing deployment/configuration policies and, in particular, evaluating the relative effectiveness of deployment/configuration policies in increasingly complex distributed-computer-system environments may be difficult or practically infeasible for many administrators and managers and may be associated with undesirable or intolerable levels of risk. The currently disclosed machine-learning-based deployment/configuration-policy evaluation methods and systems represent a significant improvement to policy-based management and control that address both of these problems.

### TECHNICAL FIELD

The current document is directed to distributed computer systems and distributed-computer-system management and, in particular, to machine-learning-based methods and systems that determine workload characteristics of computational entities from stored data and to use the determined workload characteristics to evaluate deployment/configuration policies to facilitate policy creation and ongoing policy controlled management of distributed applications and other computational entities hosted by distributed computer systems.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. However, despite all of these advances, the rapid increase in the size and complexity of computing systems has been accompanied by numerous scaling issues and technical challenges, including technical challenges associated with communications overheads encountered in parallelizing computational tasks among multiple processors, component failures, and distributed-system management. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems has, in turn, become increasingly complex, involving greater computational overheads and significant inefficiencies and deficiencies. In fact, many desired management-and-administration functionalities are becoming sufficiently complex to render traditional approaches to the design and implementation of automated management and administration systems impractical, from a time and cost standpoint, and even from a feasibility standpoint. Therefore, designers and developers of various types of automated management and control systems related to distributed computing systems are seeking alternative design-and-implementation methodologies, including machine-learning-based approaches. The application of machine-learning technologies to the management of complex computational environments is still in early stages, but promises to expand the practically achievable feature sets of automated administration-and-management systems, decrease development costs, and provide a basis for more effective optimization. In addition, administration-and-management control systems developed for distributed computer systems can often be applied to administer and manage standalone computer systems and individual, networked computer systems.

### SUMMARY

The current document is directed to methods and systems that determine workload characteristics of computational entities from stored data and that evaluate deployment/configuration policies in order to facilitate deploying, launching, and controlling distributed applications, distributed-application components, and other computational entities within distributed computer systems. Deployment/configuration policies are powerful tools for assisting managers and administrators of distributed applications and distributed computer systems, but constructing deployment/configuration policies and, in particular, evaluating the relative effectiveness of deployment/configuration policies in increasingly complex distributed-computer-system environments may be difficult or practically infeasible for many administrators and managers and may be associated with undesirable or intolerable levels of risk. The currently disclosed machine-learning-based deployment/configuration-policy evaluation methods and systems represent a significant improvement to policy-based management and control that address both of these problems.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 illustrates fundamental components of a feed-forward neural network.

FIG. 12 illustrates a small, example feed-forward neural network.

FIG. 13 provides a concise pseudocode illustration of the implementation of a simple feed-forward neural network.

FIG. 14 illustrates back propagation of errors through a neural network during training.

FIGS. 15A-B show the details of the weight-adjustment calculations carried out during back propagation.

FIGS. 16A-B illustrate neural-network training as an example of machine-learning-based-subsystem training.

FIGS. 17A-F illustrate a matrix-operation-based method for neural-network training.

FIGS. 18A-B illustrate an example configuration and deployment of a distributed application to a distributed computer system.

FIG. 19 illustrates a machine-learning-based policy evaluator that addresses the above-mentioned problems associated with deployment/configuration policies.

FIG. 20 illustrates one implementation of the currently disclosed deployment/configuration-policy evaluator E.

FIG. 21 illustrates the meaning of the term “policy” in the current document.

FIGS. 22A-B provide control-flow diagrams that illustrate use of the currently disclosed deployment/configuration-policy evaluator to determine a better policy for a currently running distributed application.

FIG. 23 illustrates a simple autoencoder.

FIG. 24 illustrates more complex autoencoders.

FIG. 25 illustrates use of the Kullback-Leibler divergence as a regularization term.

FIG. 26 illustrates generative use of an autoencoder as well as a serious problem related to generative use of an autoencoder.

FIG. 27 illustrates a solution to the problem with generative use of autoencoders discussed in the preceding paragraph of this document.

FIG. 28 illustrates the architecture of a variational autoencoder.

FIG. 29 illustrates yet another type of autoencoder referred to as a “conditional variational autoencoder.”

FIG. 30 provides a 2-dimensional representation of the latent space of a conditional variational autoencoder.

FIG. 31 illustrates the performance-estimator component of the currently disclosed deployment/configuration-policy evaluator.

### DETAILED DESCRIPTION

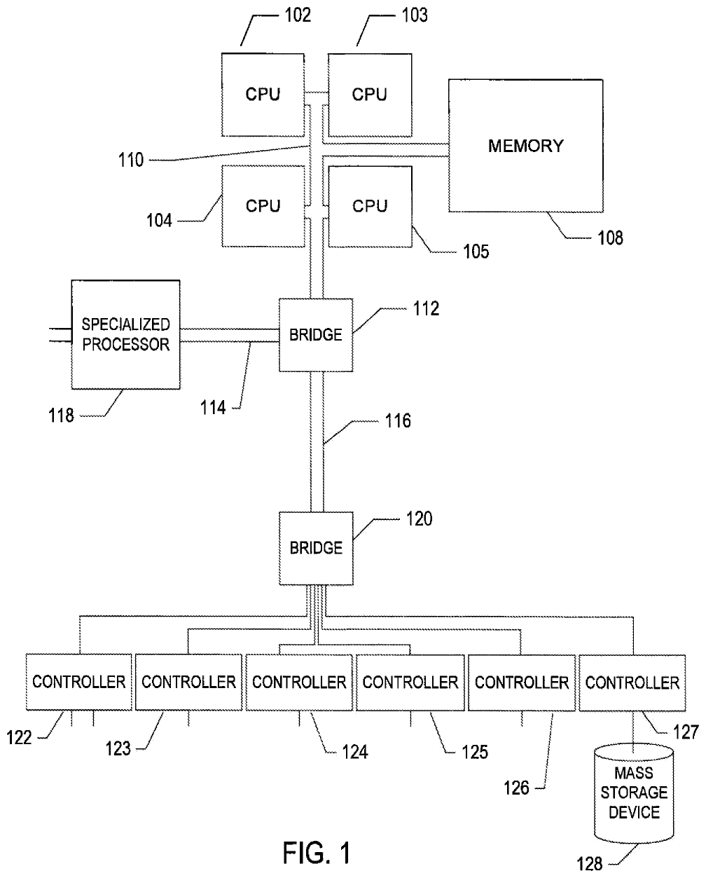

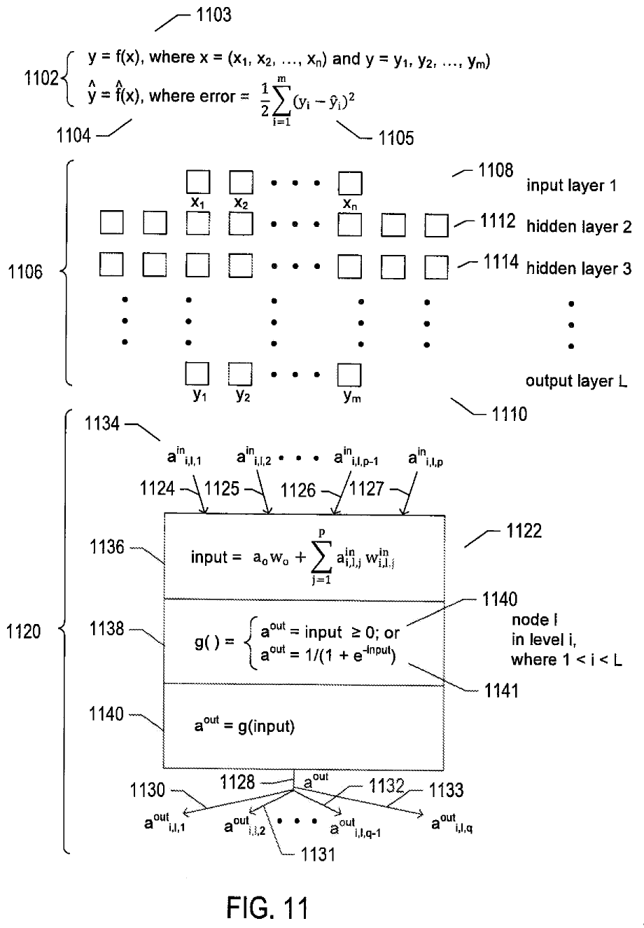

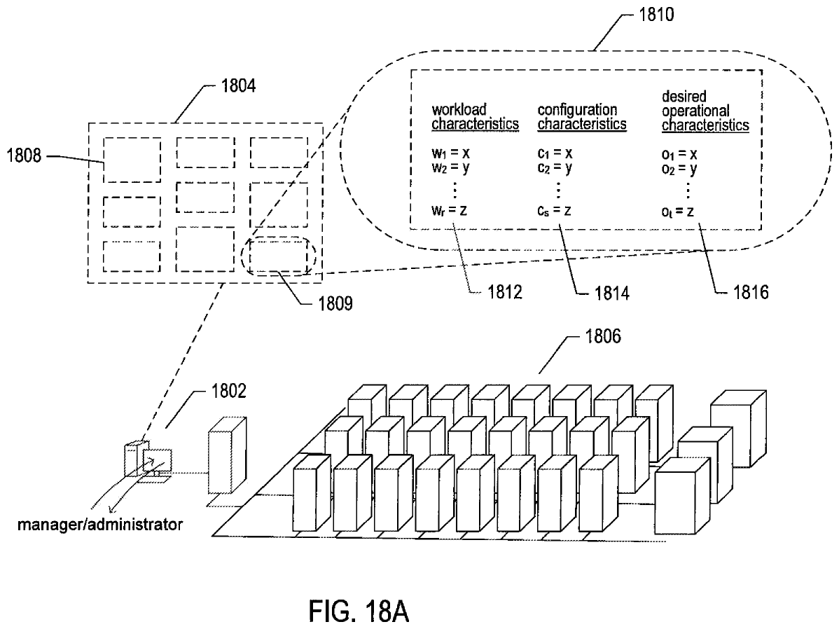

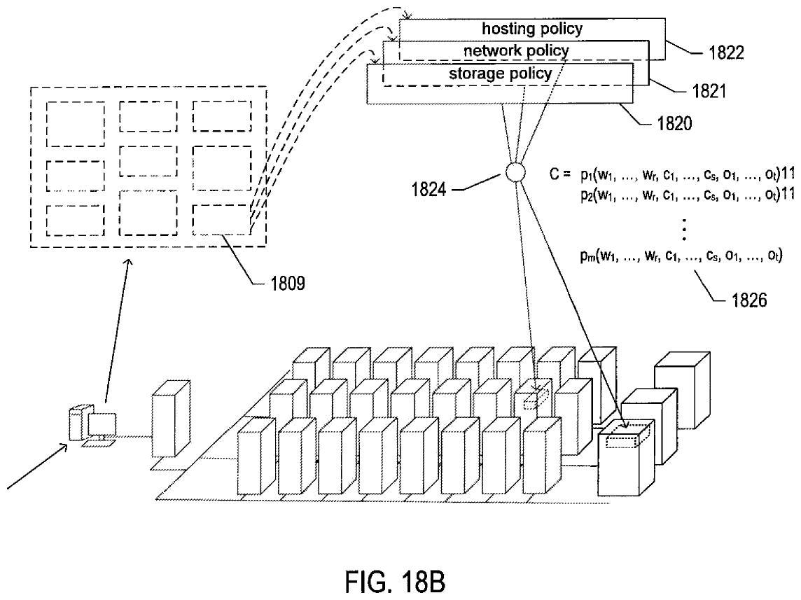

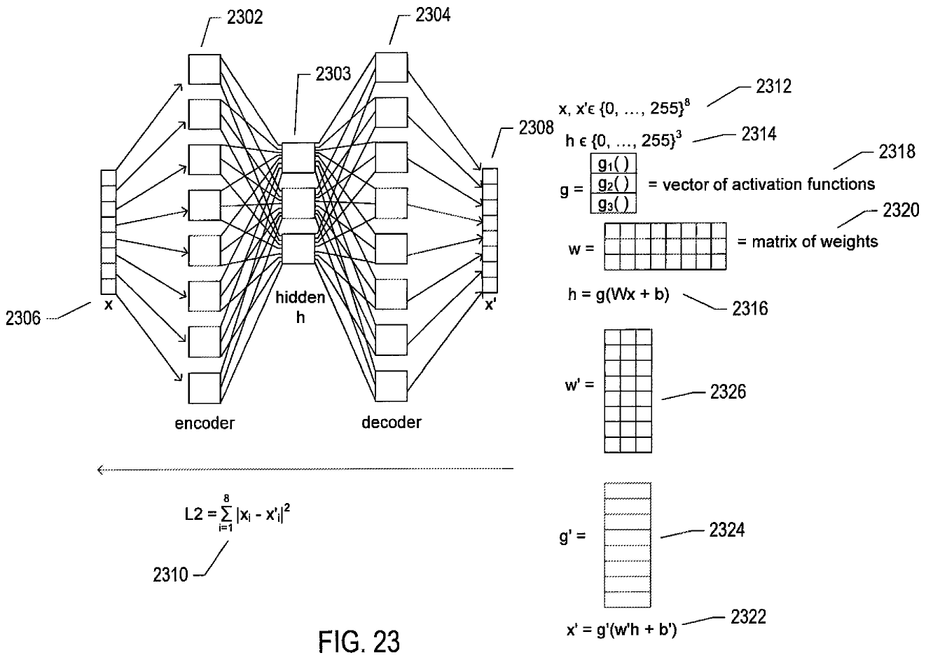

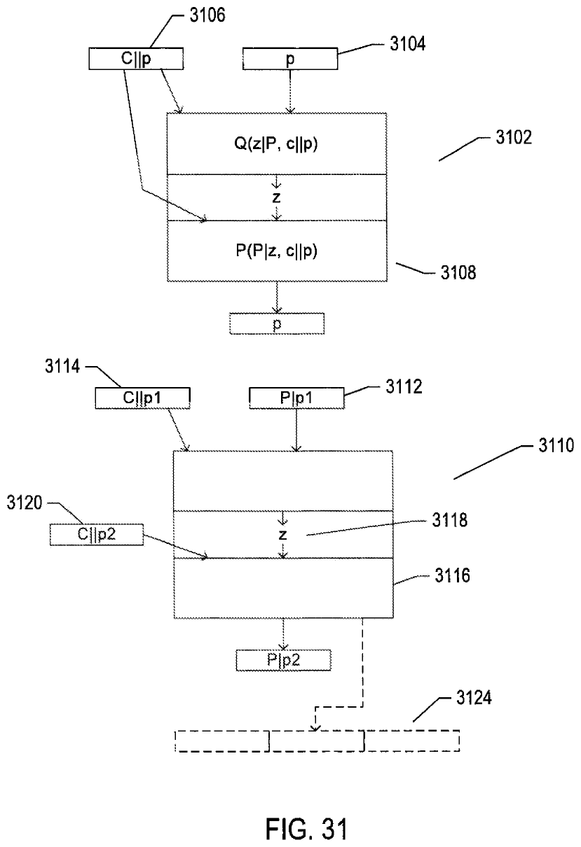

The current document is directed to machine-learning-based systems and methods that determine workload characteristics of computational entities and that evaluate deployment/configuration policies. In a first subsection, below, a detailed description of computer hardware, complex computational systems, and virtualization is provided with reference to FIGS. 1-10. In a second subsection, neural networks are discussed with reference to FIGS. 11-17F. In a third subsection, the currently disclosed systems and methods that evaluate deployment/configuration policies are discussed with reference to FIGS. 18A-22B. In a fourth subsection, autoencoders, variational autoencoders, and conditional variational autoencoders are discussed with reference to FIGS. 23-30. In a fifth subsection, additional details regarding the currently disclosed methods and systems are discussed with reference to FIG. 31.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

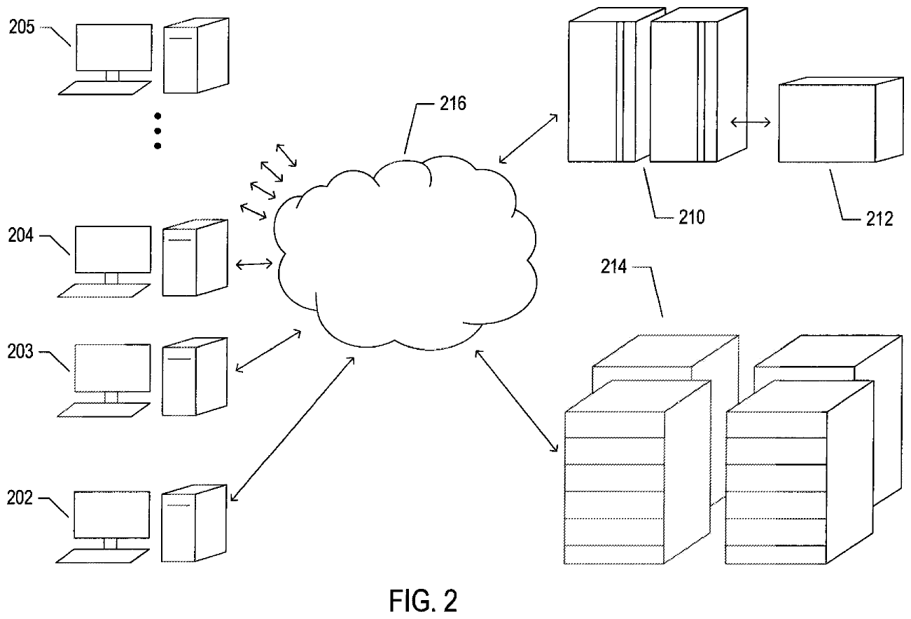

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

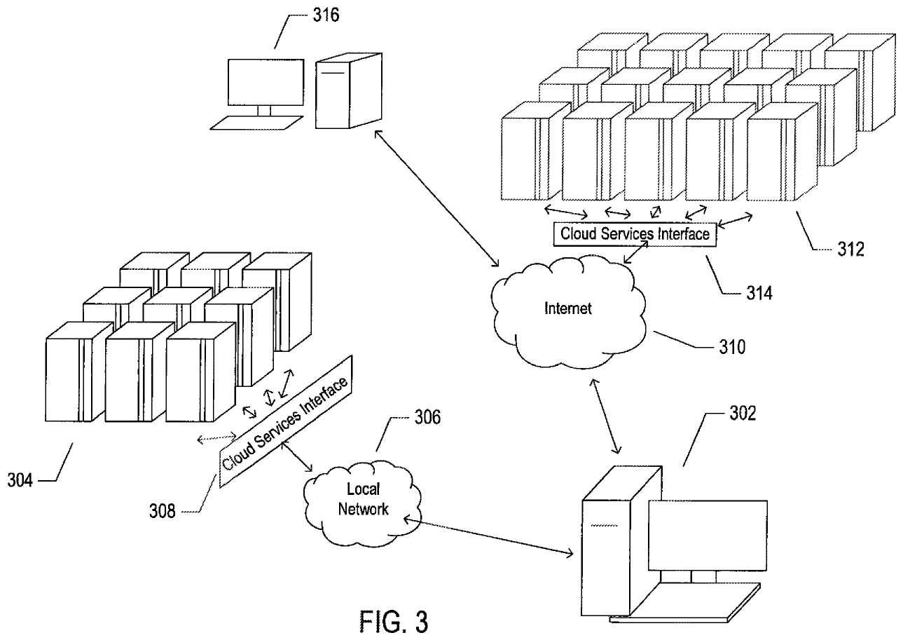

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

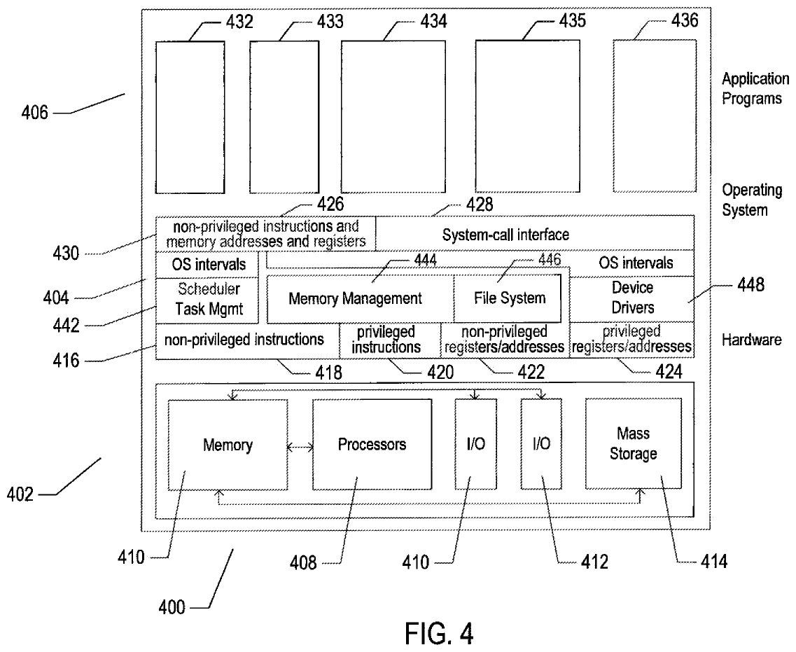

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different pes of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

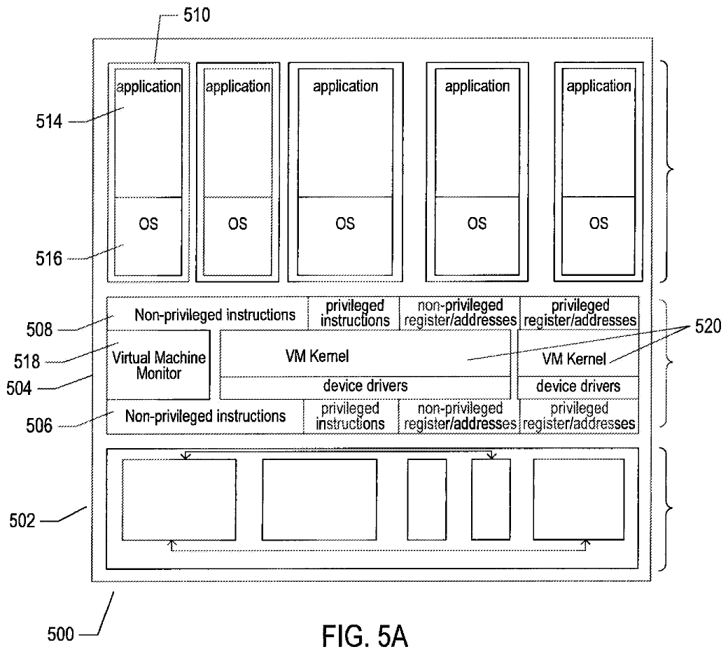

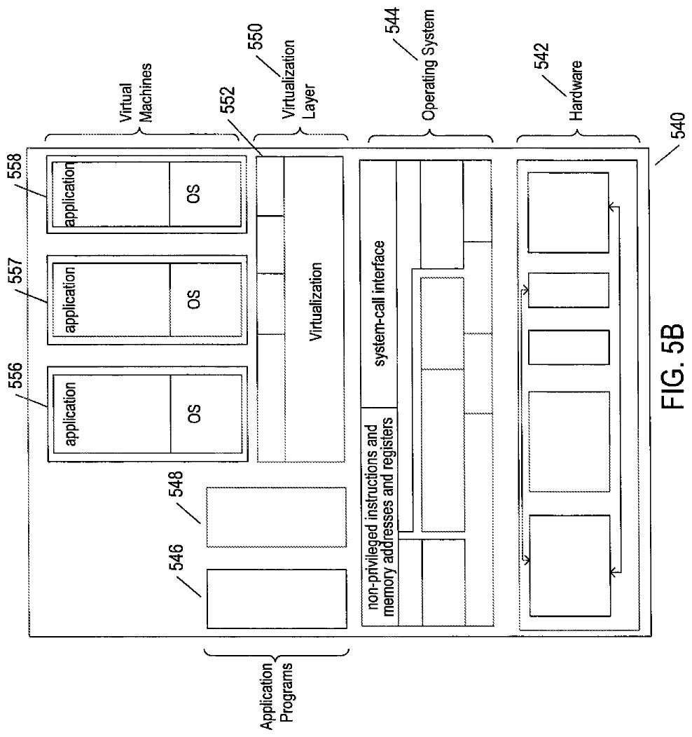

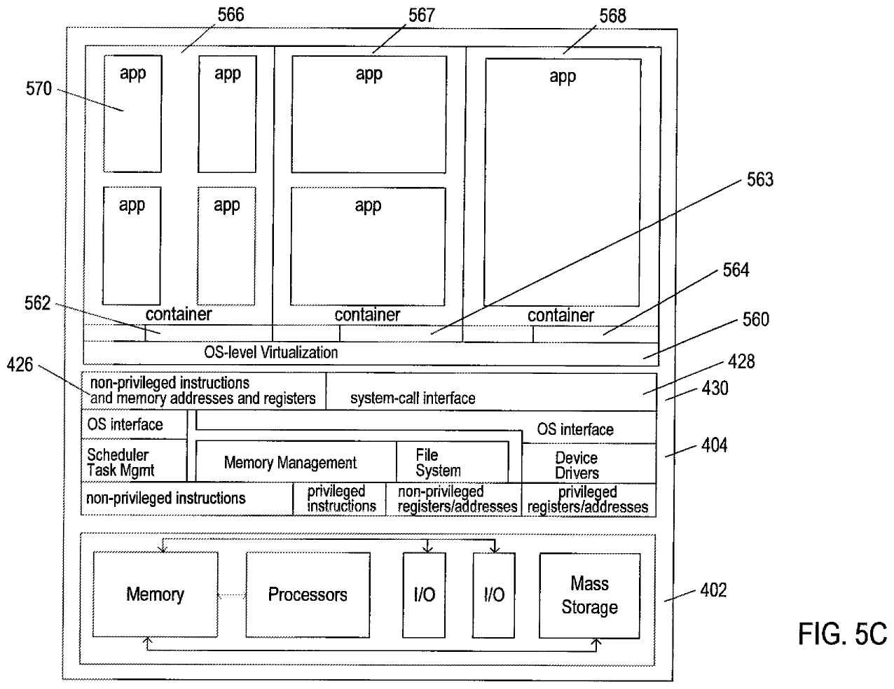

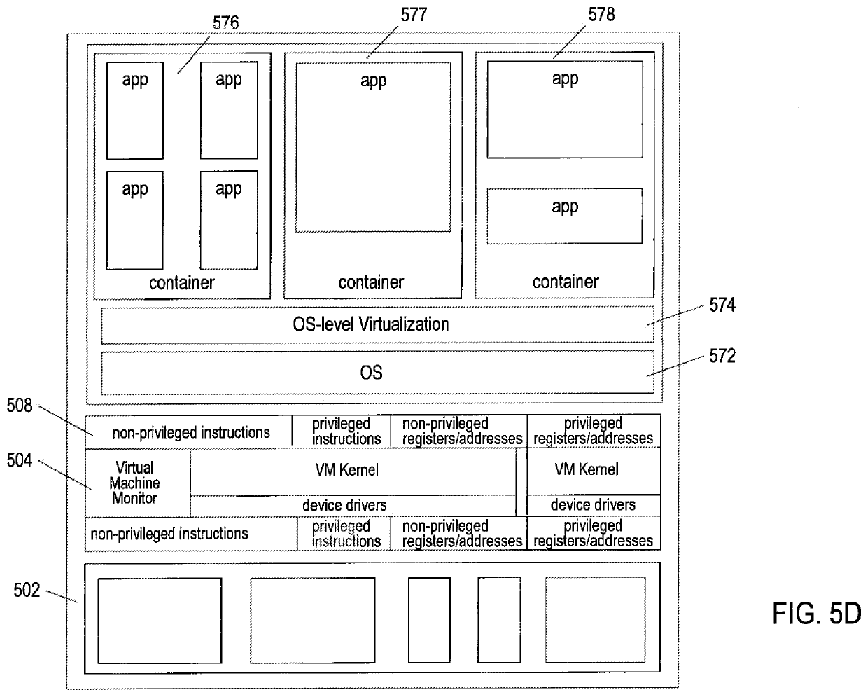

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-laver interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous, distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system. OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating stems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

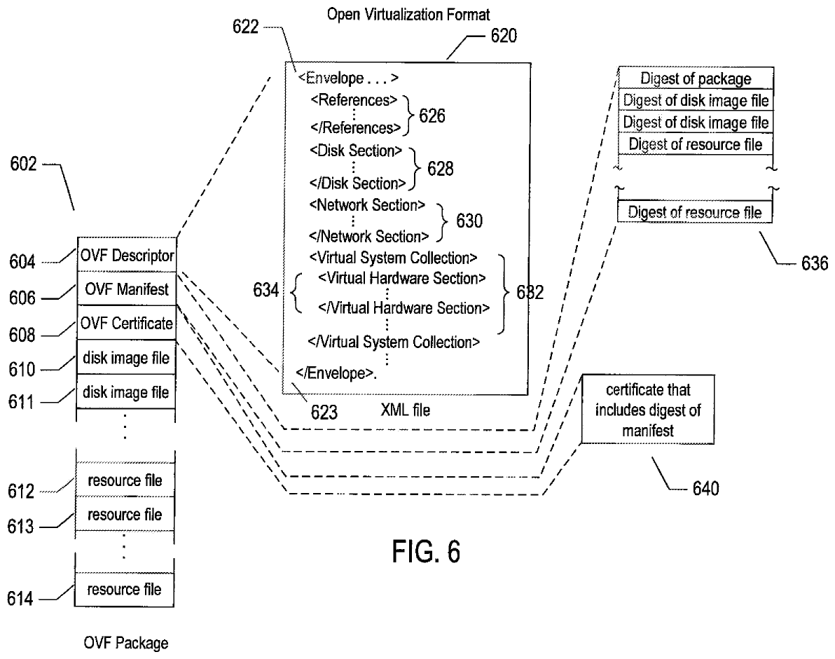

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known took for transmitting, distributing, and loading files. A virtual appliance is a software service that is delivered as a complete software stack installed within one or more virtual machines that is encoded within an OVF package.

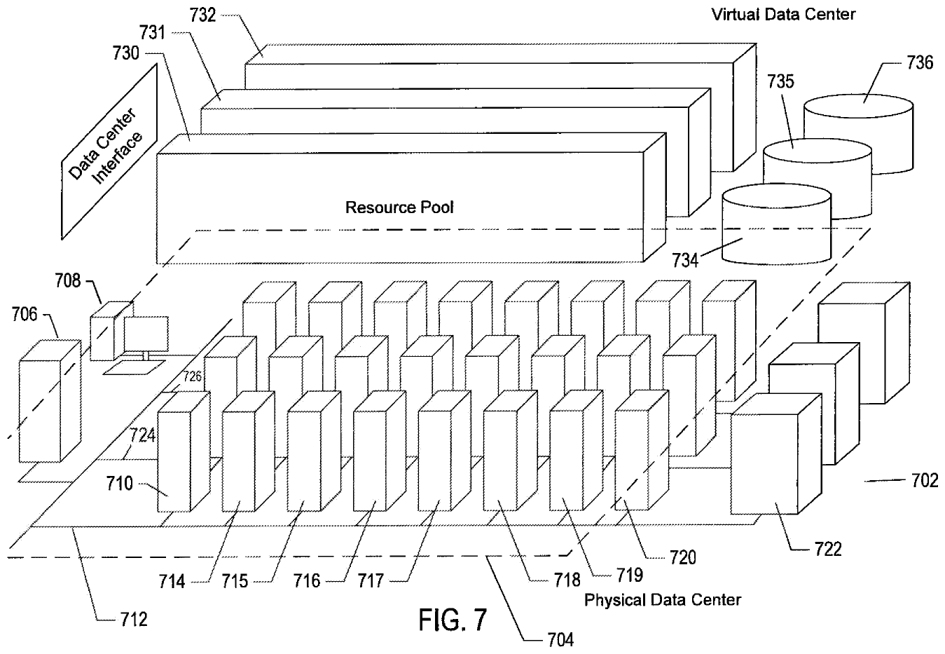

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound,. suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

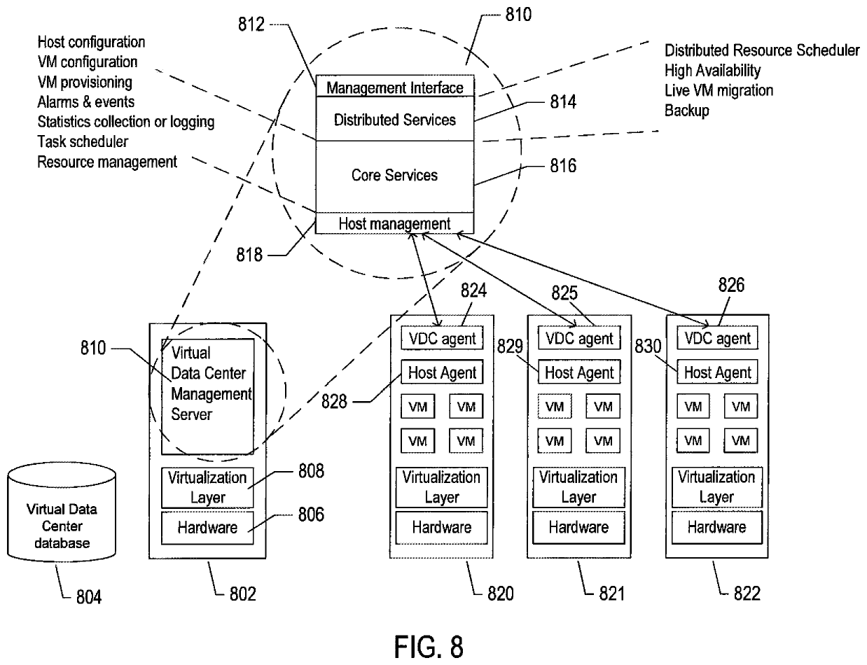

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808 and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

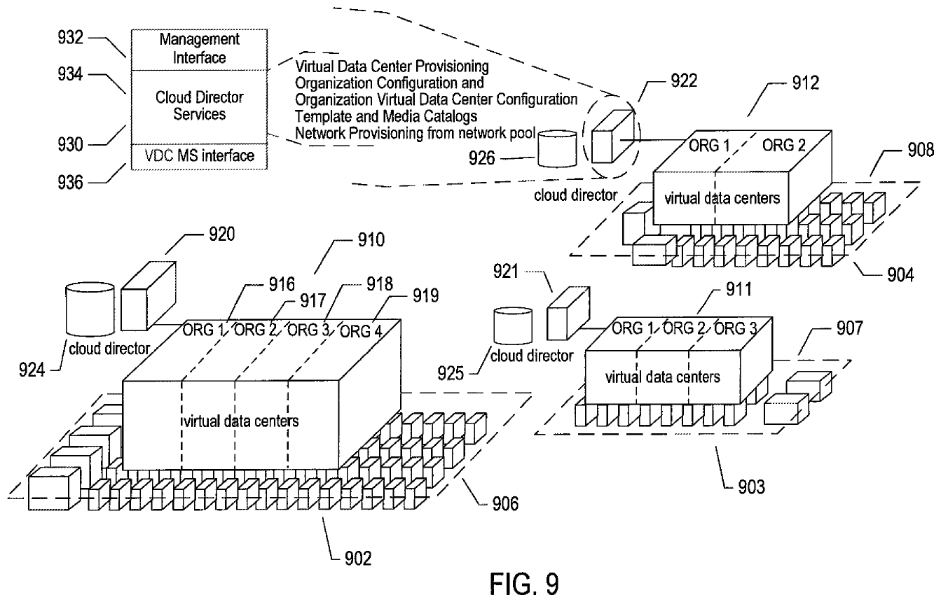

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

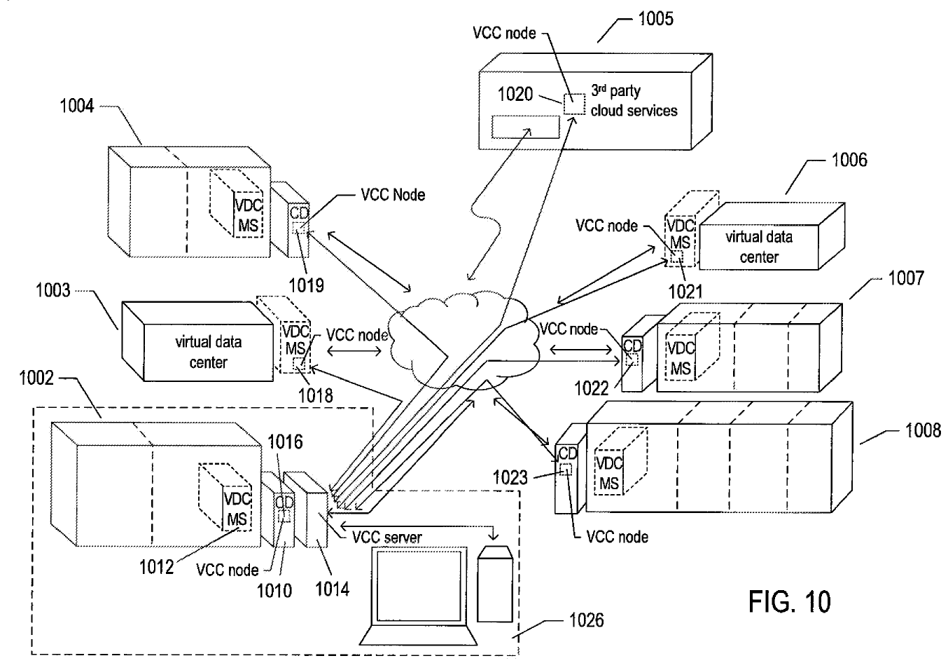

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC servers and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Neural Networks

FIG. 11 illustrates fundamental components of a feed-forward neural network. Equations 1102 mathematically represent ideal operation of a neural network as a function ƒ(x). The function receives an input vector x and outputs a corresponding output vector y 1103. For example, an input vector may be a digital image represented by a two-dimensional array of pixel values in an electronic document or may be an ordered set of numeric or alphanumeric values. Similarly, the output vector may be, for example, an altered digital image, an ordered set of one or more numeric or alphanumeric values, an electronic document, or one or more numeric values. The initial expression 1103 represents the ideal operation of the neural network. In other words, the output vectors y represent the ideal, or desired, output for corresponding input vector x. However, in actual operation, a physically implemented neural network \hat{ƒ}(x), as represented by expressions 1104, returns a physically generated output vector ŷ that may differ from the ideal or desired output vector y. As shown in the second expression 1105 within expressions 1104, an output vector produced by the physically implemented neural network is associated with an error or loss value. A common error or loss value is the square of the distance between the two points represented by the ideal output vector and the output vector produced by the neural network. To simplify back-propagation computations, discussed below, the square of the distance is often divided by 2. As further discussed below, the distance between the two points represented by the ideal output vector and the output vector produced by the neural network, with optional scaling, may also be used as the error or loss. A neural network is trained using a training dataset comprising input-vector/ideal-output-vector pairs, generally obtained by human or human-assisted assignment of ideal-output vectors to selected input vectors. The ideal-output vectors in the training dataset are often referred to as “labels.” During training, the error associated with each output vector, produced by the neural network in response to input to the neural network of a training-dataset input vector, is used to adjust internal weights within the neural network in order to minimize the error or loss. Thus, the accuracy and reliability of a trained neural network is highly dependent on the accuracy and completeness of the training dataset.

As shown in the middle portion 1106 of FIG. 11, a feed-forward neural network generally consists of layers of nodes, including an input layer 1108, an output layer 1110, and one or more hidden layers 1112 and 1114. These layers can be numerically labeled 1, 2, 3, . . . , L, as shown in FIG. 11. In general, the input layer contains a node for each element of the input vector and the output layer contains one node for each element of the output vector. The input layer and/or output layer may have one or more nodes. In the following discussion, the nodes of a first level with a numeric label lower in value than that of a second layer are referred to as being higher-level nodes with respect to the nodes of the second layer. The input-layer nodes are thus the highest-level nodes. The nodes are interconnected to form a graph.

The lower portion of FIG. 11 (1120 in FIG. 11) illustrates a feed-forward neural-network node. The neural-network node 1122 receives inputs 1124-1127 from one or more next-higher-level nodes and generates an output 1128 that is distributed to one or more next-lower-level nodes 1130-1133. The inputs and outputs are referred to as “activations,” represented by superscript-and-subscript symbols “a” in FIG. 11, such as the activation symbol 1134. An input component 1136 within a node collects the input activations and generates a weighted sum of these input activations to which a weighted internal activation a₀ is added. An activation component 1138 within the node is represented by a function g( ) referred to as an “activation function,” that is used in an output component 1140 of the node to generate the output activation of the node based on the input collected by the input component 1136. The neural-network node 1122 represents a generic hidden-layer node. Input-layer nodes lack the input component 1136 and each receive a single input value representing an element of an input vector. Output-component nodes output a single value representing an element of the output vector. The values of the weights used to generate the cumulative input by the input component 1136 are determined by training, as previously mentioned. In general, the input, outputs, and activation function are predetermined and constant, although, in certain types of neural networks, these may also be at least partly adjustable parameters. In FIG. 11, two different possible activation functions are indicated by expressions 1140 and 1141. The latter expression represents a sigmoidal relationship between input and output that is commonly used in neural networks and other types of machine-learning systems.

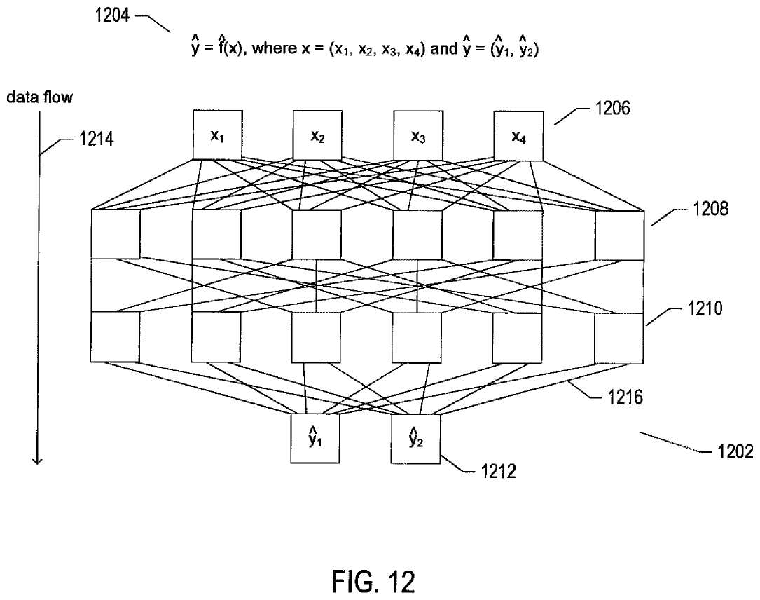

FIG. 12 illustrates a small, example feed-forward neural network, illustrates a small, example feed-forward neural network. The example neural network 1202 is mathematically represented by expression 1204. It includes an input layer of four nodes 1206, a first hidden layer 1208 of six nodes, a second hidden layer 1210 of six nodes, and an output layer 1212 of two nodes. As indicated by directed arrow 1214, data input to the input-layer nodes 1206 flows downward through the neural network to produce the final values output by the output nodes in the output layer 1212. The line segments, such as line segment 1216, interconnecting the nodes in the neural network 1202 indicate communications paths along which activations are transmitted from higher-level nodes to lower-level nodes. In the example feed-forward neural network, the nodes of the input layer 1206 are fully connected to the nodes of the first hidden layer 1208, but the nodes of the first hidden layer 1208 are only sparsely connected with the nodes of the second hidden layer 1210. Various different types of neural networks may use different numbers of layers, different numbers of nodes in each of the layers, and different patterns of connections between the nodes of each layer to the nodes in preceding and succeeding layers.

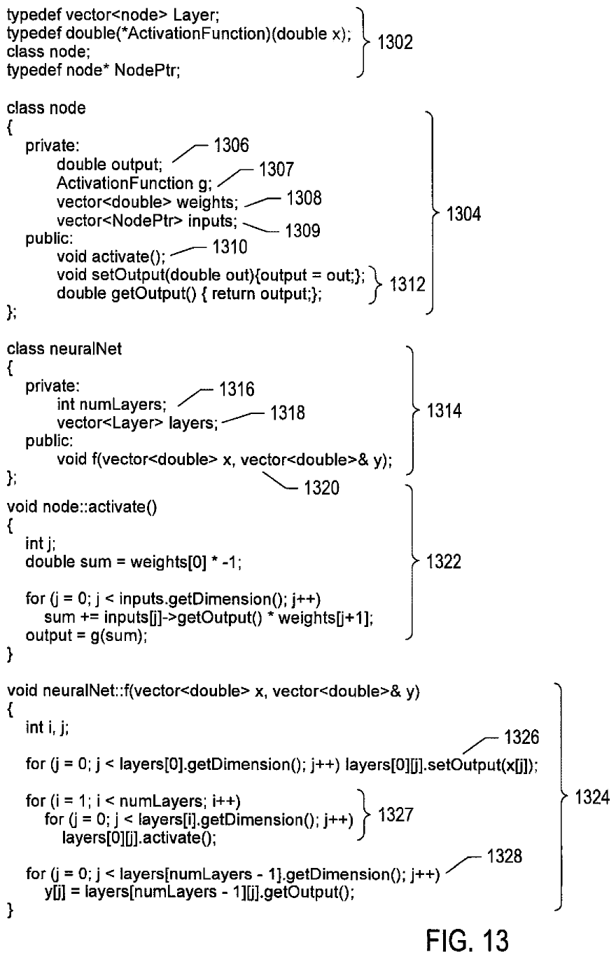

FIG. 13 provides a concise pseudocode illustration of the implementation of a simple feed-forward neural network. Three initial type definitions 1302 provide types for layers of nodes, pointers to activation functions, and pointers to nodes. The class node 1304 represents a neural-network node. Each node includes the following data members: (1) output 1306, the output activation value for the node: (2) g 1307, a pointer to the activation function for the node: (3) weights 1308, the weights associated with the inputs; and (4) inputs 1309, pointers to the higher-level nodes from which the node receives activations. Each node provides an activate member function 1310 that generates the activation for the node, which is stored in the data member output, and a pair of member functions 1312 for setting and getting the value stored in the data member output. The class neuralNet 1314 represents an entire neural network. The neural network includes data members that store the number of layers 1316 and a vector of node-vector layers 1318, each node-vector layer representing a layer of nodes within the neural network. The single member function ƒ 1320 of the class neuralNet generates an output vector y for an input vector x. An implementation of the member function activate for the node class is next provided 1322. This corresponds to the expression shown for the input component 1136 in FIG. 11. Finally, an implementation for the member function ƒ 1324 of the neuralNet class is provided. In a first for-loop 1326, an element of the input vector is input to each of the input-layer nodes. In a pair of nested for-loops 1327, the activate function for each hidden-layer and output-layer node in the neural network is called, starting from the highest hidden layer and proceeding layer-by-layer to the output layer. In a final for-loop 1328, the activation values of the output-layer nodes are collected into the output vector y.

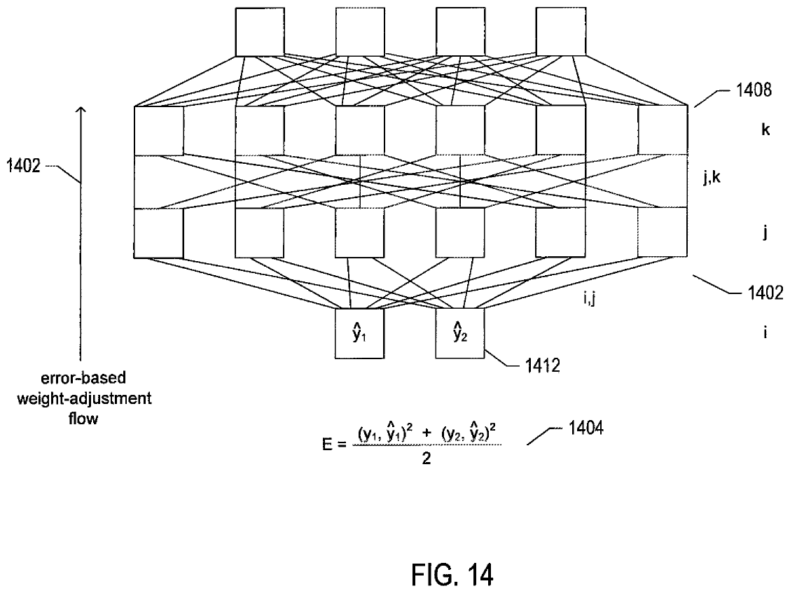

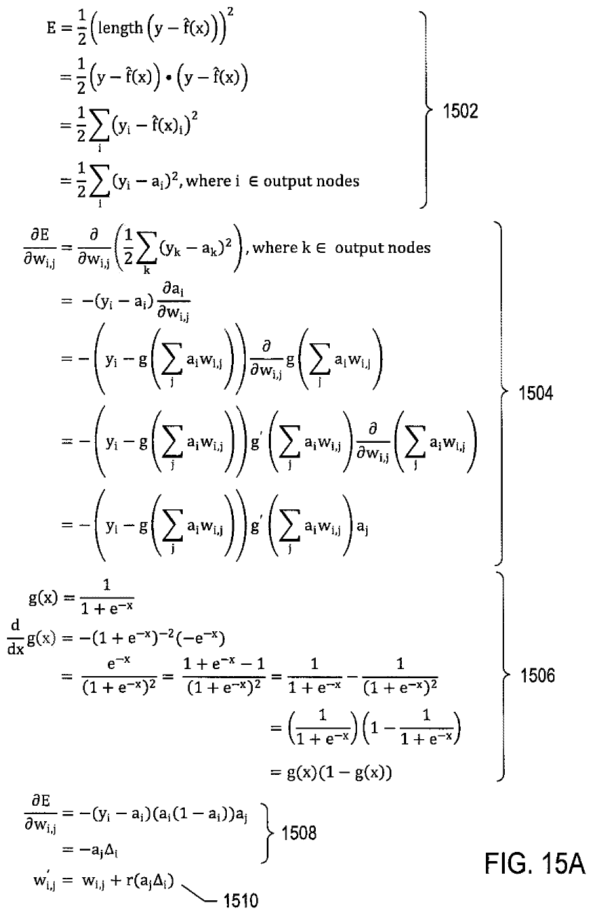

FIG. 14 illustrates back propagation of errors through a neural network during training. As indicated by directed arrow 1402, the error-based weight adjustment flows upward from the output-layer nodes 1212 to the highest-level hidden-layer nodes 1208. For the example neural network 1202, the error, or loss, is computed according to expression 1404. This loss is propagated upward through the connections between nodes in a process that proceeds in an opposite direction from the direction of activation transmission during generation of the output vector from the input vector. The back-propagation process determines, for each activation passed from one node to another, the value of the partial differential of the error, or loss, with respect to the weight associated with the activation. This value is then used to adjust the weight in order to minimize the error, or loss.

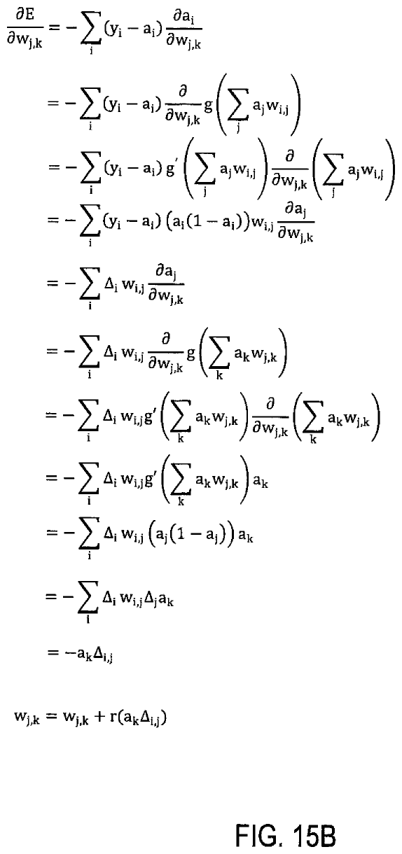

FIGS. 15A-B show the details of the weight-adjustment calculations carried out during back propagation. FIGS. 15A-B show the details of the weight-adjustment calculations carried out during back propagation. An expression for the total error, or loss, E with respect to an input-vector/label pair within a training dataset is obtained in a first set of expressions 1502, which is one half the squared distance between the points in a multidimensional space represented by the ideal output and the output vector generated by the neural network. The partial differential of the total error E with respect to a particular weight w_{i,j} for the j^{th} input of an output node i is obtained by the set of expressions 1504. In these expressions, the partial differential operator is propagated rightward through the expression for the total error E. An expression for the derivative of the activation function with respect to the input x produced by the input component of a node is obtained by the set of expressions 1506. This allows for generation of a simplified expression for the partial derivative of the total energy E with respect to the weight associated with the j^{th} input of the i^{th} output node 1508. The weight adjustment based on the total error E is provided by expression 1510, in which r has a real value in the range [0-1] that represents a learning rate, aⱼ is the activation received through input j by node i, and Δᵢ is the product of parenthesized terms, which include aᵢ and yᵢ, in the first expression in expressions 1508 that multiplies aⱼ. FIG. 15B provides a derivation of the weight adjustment for the hidden-layer nodes above the output layer. It should be noted that the computational overhead for calculating the weights for each next highest layer of nodes increases geometrically, as indicated by the increasing number of subscripts for the Δ multipliers in the weight-adjustment expressions.

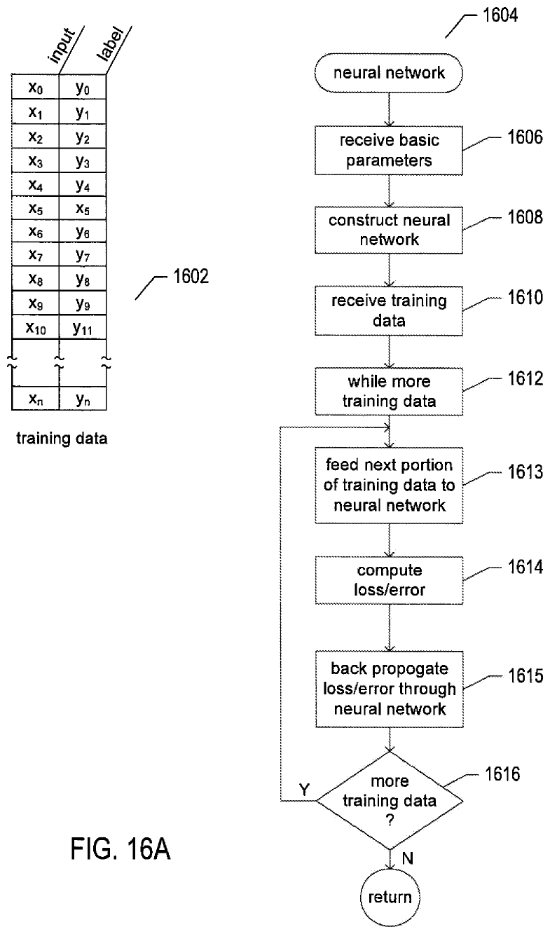

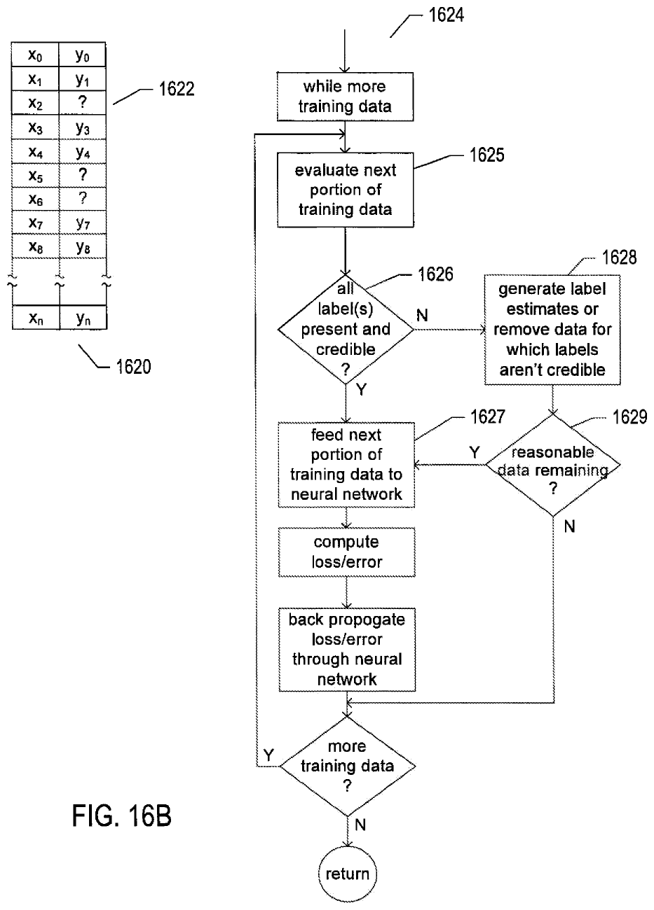

FIGS. 16A-B illustrate neural-network training as an example of machine-learning-based-subsystem training. FIG. 16A illustrates the construction and training of a neural network using a complete and accurate training dataset. The training dataset is shown as a table of input-vector/label pairs 1602, in which each row represents an input-vector/label pair. The control-flow diagram 1604 illustrates construction and training of a neural network using the training dataset. In step 1606, basic parameters for the neural network are received, such as the number of layers, number of nodes in each layer, node interconnections, and activation functions. In step 1608, the specified neural network is constructed. This involves building representations of the nodes, node connections, activation functions, and other components of the neural network in one or more electronic memories and may involve, in certain cases, various types of code generation, resource allocation and scheduling, and other operations to produce a fully configured neural network that can receive input data and generate corresponding outputs. In many cases, for example, the neural network may be distributed among multiple computer systems and may employ dedicated communications and shared memory for propagation of activations and total error or loss between nodes. It should again be emphasized that a neural network is a physical system comprising one or more computer systems, communications subsystems, and often multiple instances of computer-instruction-implemented control components.

In step 1610, training data represented by table 1602 is received. Then, in the while-loop of steps 1612-1616, portions of the training data are iteratively input to the neural network, in step 1613, the loss or error is computed, in step 1614, and the computed loss or error is back-propagated through the neural network step 1615 to adjust the weights. The control-flow diagram refers to portions of the training data rather than individual input-vector/label pairs because, in certain cases, groups of input-vector/label pairs are processed together to generate a cumulative error that is back-propagated through the neural network. A portion may, of course, include only a single input-vector/label pair.

FIG. 16B illustrates one method of training a neural network using an incomplete training dataset. Table 1620 represents the incomplete training dataset. For certain of the input-vector/label pairs, the label is represented by a “?” symbol, such as in the input-vector/label pair 1622. The “?” symbol indicates that the correct value for the label is unavailable. This type of incomplete data set may arise from a variety of different factors, including inaccurate labeling by human annotators, various types of data loss incurred during collection, storage, and processing of training datasets, and other such factors. The control-flow diagram 1624 illustrates alterations in the while-loop of steps 1612-1616 in FIG. 16A that might be employed to train the neural network using the incomplete training dataset. In step 1625, a next portion of the training dataset is evaluated to determine the status of the labels in the next portion of the training data. When all of the labels are present and credible, as determined in step 1626, the next portion of the training dataset is input to the neural network, in step 1627, as in FIG. 16A. However, when certain labels are missing or lack credibility, as determined in step 1626, the input-vector/label pairs that include those labels are removed or altered to include better estimates of the label values, in step 1628. When there is reasonable training data remaining in the training-data portion following step 1628, as determined in step 1629, the remaining reasonable data is input to the neural network in step 1627. The remaining steps in the while-loop are equivalent to those in the control-flow diagram shown in FIG. 16A. Thus, in this approach, either suspect data is removed, or better labels are estimated, based on various criteria, for substitution for the suspect labels.

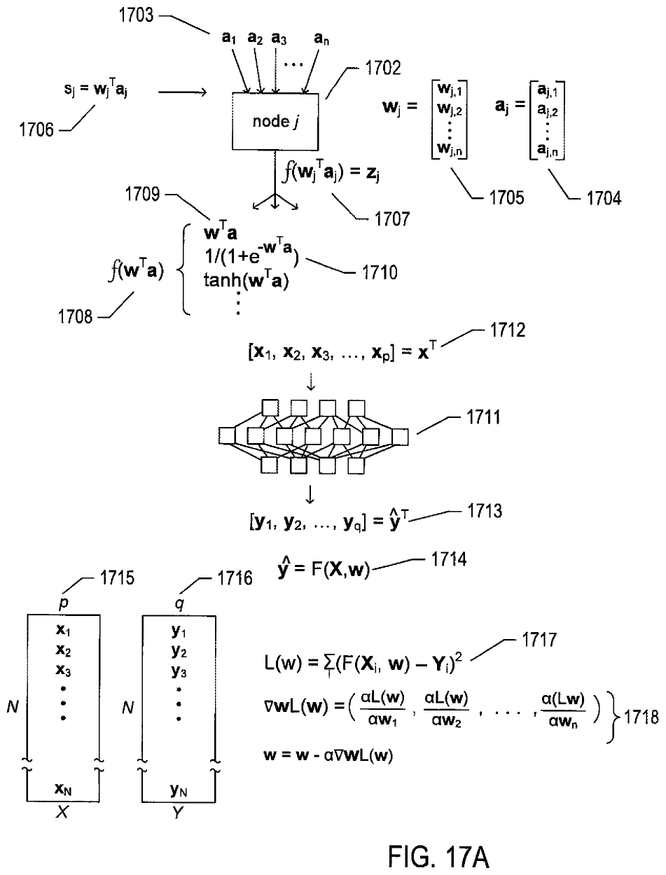

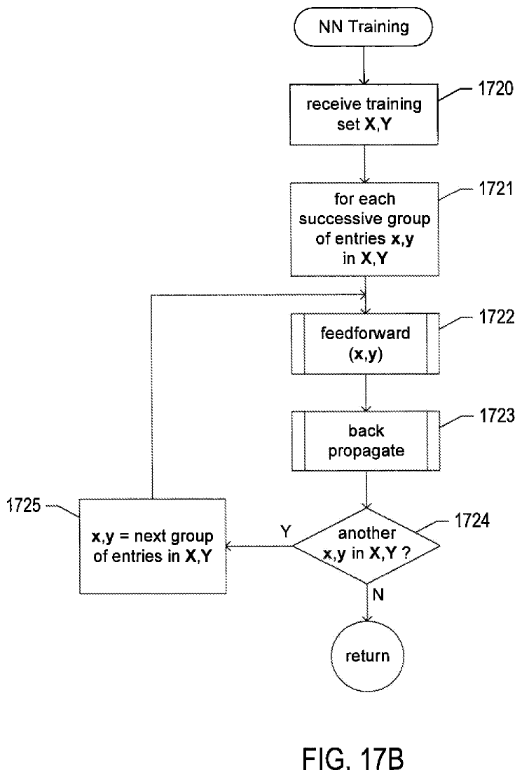

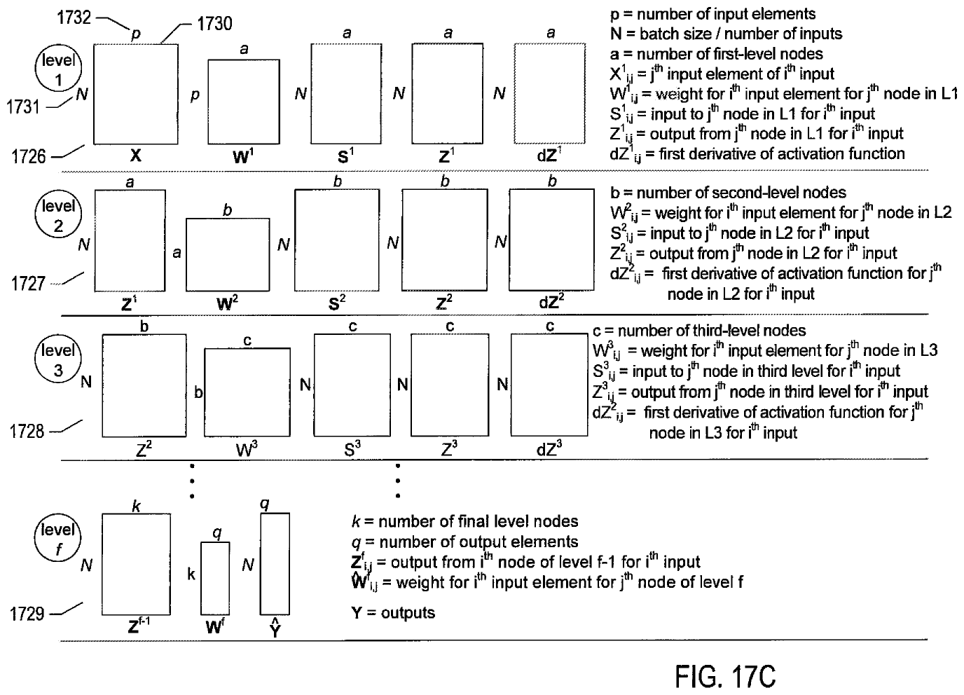

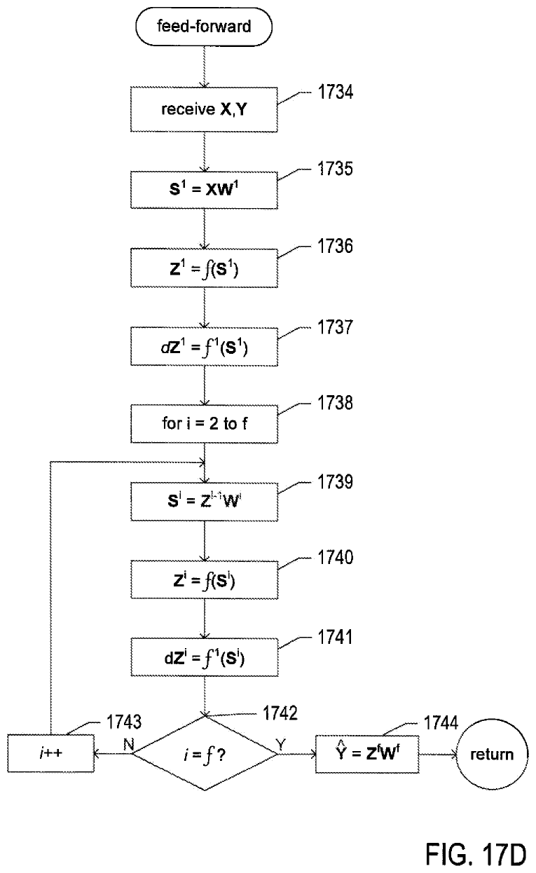

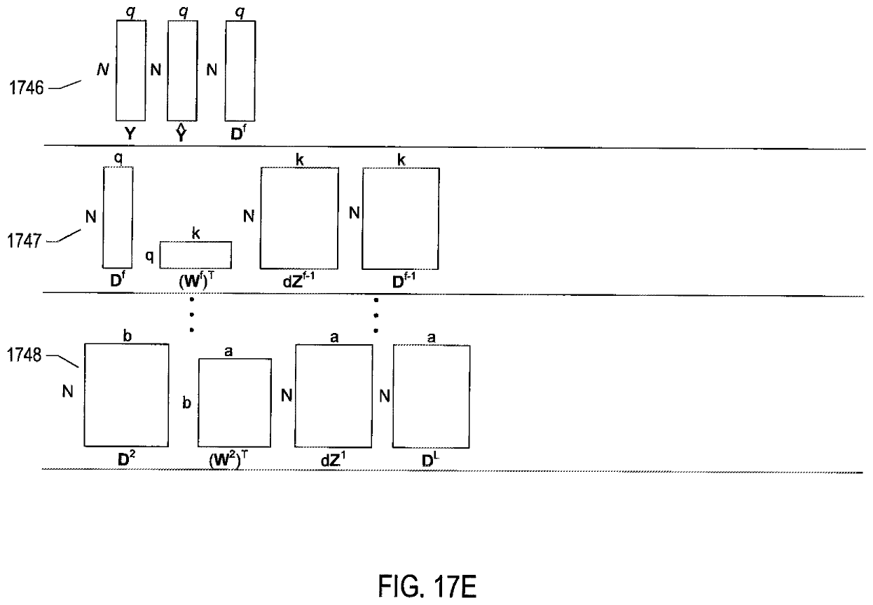

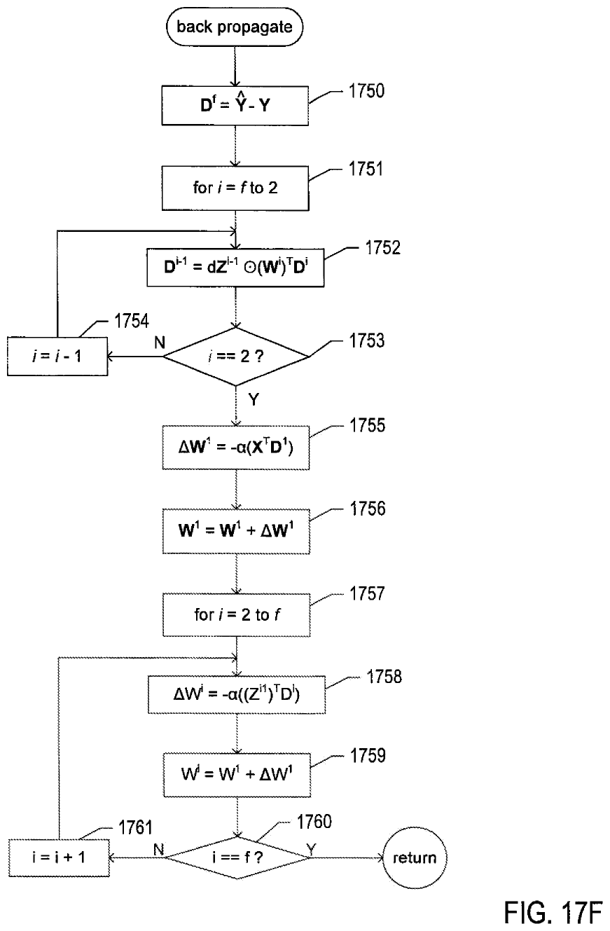

FIGS. 17A-F illustrate a matrix-operation-based method for neural-network training. FIG. 17A illustrates the neural network and associated terminology. As discussed above, each node in the neural network, such as node j 1702, receives one or more inputs a 1703, expressed as a vector aⱼ 1704, that are multiplied by corresponding weights, expressed as a vector wⱼ 1705, and added together to produce an input signal sⱼ using a vector dot-product operation 1706. An activation function ƒ within the node receives the input signal sⱼ and generates an output signal zⱼ 1707 that is output to all child nodes of node j. Expression 1708 provides an example of various different types of activation functions that may be used in the neural network. These include a linear activation function 1709 and a sigmoidal activation function 1710. As discussed above, the neural network 1711 receives a vector of p input values 1712 and outputs a vector of q output values 1713. In other words, the neural network can be thought of as a function F 1714 that receives a vector of input values x^{T} and uses a current set of weights w within the nodes of the neural network to produce a vector of output values ŷ^{T} . The neural network is trained using a training data set comprising a matrix X 1715 of input values, each of N rows in the matrix corresponding to an input vector x^{T}, and a matrix Y 1716 of desired output values, or labels, each of N rows in the matrix corresponding to a desired output-value vector y^{T}. A least-squares loss function is used in training 1717 with the weights updated using a gradient vector generated from the loss function, as indicated in expressions 1718, where α is a constant that corresponds to a learning rate.

FIG. 17B provides a control-flow diagram illustrating the method of neural-network training. In step 1720, the routine “NNTraining” receives the training set comprising matrices X and Y. Then, in the for-loop of steps 1721-1725, the routine “NNTraining” processes successive groups or batches of entries x and y selected from the training set. In step 1722, the routine “NNTraining” calls a routine “feedforward” to process the current batch of entries to generate outputs and, in step 1723, calls a routine “back propagated” to propagate errors back through the neural network in order to adjust the weights associated with each node.

FIG. 17C illustrates various matrices used in the routine “feedforward.” FIG. 17C is divided horizontally into four regions 1726-1729. Region 1726 approximately corresponds to the input level, regions 1727-1728 approximately correspond to hidden-node levels, and region 1729 approximately corresponds to the final output level. The various matrices are represented, in FIG. 17C, as rectangles, such as rectangle 1730 representing the input matrix X. The row and column dimensions of each matrix are indicated, such as the row dimension N 1731 and the column dimension p 1732 for input matrix X 1730. In the right-hand portion of each region in FIG. 17C, descriptions of the matrix-dimension values and matrix elements are provided. In short,, the matrices W^{x} represent the weights associated with the nodes at level x. the matrices S^{x} represent the input signals associated with the nodes at level x, the matrices Z^{x} represent the outputs from the nodes at level x, and the matrices dZ^{x} represent the first derivative of the activation function for the nodes at level x evaluated for the input signals.

FIG. 17D provides a control-flow diagram for the routine “feedforward.,” called in step 1722 of FIG. 17B. In step 1734, the routine “feedforward” receives a set of training data x and y selected from the training-data matrices X and Y. In step 1735, the routine “feedforward” computes the input signals Sⁱ for the first layer of nodes by matrix multiplication of matrices x and Wⁱ, where matrix Wⁱ contains the weights associated with the first-layer nodes. In step 1736, the routine “feedforward” computes the output signals Zⁱ for the first-layer nodes by applying a vector-based activation function ƒ to the input signals S¹. In step 1737, the routine “feedforward” computes the values of the derivatives of the activation function ƒⁱ. dZⁱThen, in the for-loop of steps 1738-1743, the routine “feedforward” computes the input signals Sⁱ, the output signals Zⁱ, and the derivatives of the activation function dZⁱ for the nodes of the remaining levels of the neural network. Following completion of the for-loop of steps 1738-1743, the routine “feedforward” computes the output values ŷ^{T} for the received set of training data.

FIG. 17E illustrates various matrices used in the routine “back propagate.” FIG. 17E uses similar illustration conventions as used in FIG. 17C, and is also divided horizontally into horizontal regions 1746-1748. Region 1746 approximately corresponds to the output level, region 1747 approximately corresponds to hidden-node levels, and region 1748 approximately corresponds to the first node level. The only new type of matrix shown in FIG. 17E are the matrices D^{x} for node levels x. These matrices contain the error signals that are used to adjust the weights of the nodes.

FIG. 17F provides a control-flow diagram for the routine “back propagate.” In step 1750, the routine “back propagate” computes the first error-signal matrix D^{ƒ} as the difference between the values ŷ output during a previous execution of the routine “feedforward” and the desired output values from the training set y. Then, in for-loop of steps 1751-1754, the routine “back propagate” computes the remaining error-signal matrices for each of the node levels up to the first node level as the Shur product of the dZ matrix and the product of the transpose of the W matrix and the error-signal matrix for the next lower node level. In step 1755, the routine “back propagate” computes weight adjustments ΔW for the first-level nodes as the negative of the constant α times the product of the transpose of the input-value matrix and the error-signal matrix. In step 1756, the first-node-level weights are adjusted by adding the current W matrix and the weight-adjustments matrix ΔW. Then, in the for-loop of steps 1757-1761, the weights of the remaining node levels are similarly adjusted.

Thus, as shown in FIGS. 17A-F, neural-network training can be conducted as a series of simple matrix operations, including matrix multiplications, matrix transpose operations, matrix addition, and the Shur product. Interestingly, there are no matrix inversions or other complex matrix operations needed for neural-network training.

### Currently Disclosed Methods and Systems for Policy Evaluation

FIGS. 18A-B illustrate an example configuration and deployment of a distributed application to a distributed computer system. In this example, as shown in FIG. 18A, a manager or administrator interacts with a management interface 1802 to create a specification 1804 for a distributed application that is to be configured and deployed in a set of virtual machines running within a distributed computer system 1806. The distributed application includes multiple different component distributed-application instances. In this example, the deployment and configuration of each distributed-application instance is specified by a component specification, such as component specifications 1808-1809, within the overall specification 1804 of the distributed application. In this example, a component specification, shown in inset 1810 for component 1809, includes a set of workload characteristics 1812, configuration characteristics 1814, and desired operational characteristics 1816. In many specifications, workload characteristics may be only indirectly specified, and therefore need to be derived from the specifications, but, for illustration purposes, such details are not discussed in the current document. There are many different ways to formally specify configuration characteristics and desired operational characteristics. The example component specification shown in inset 1810 employees a generic representation of the workload-characteristics, configuration-characteristics, and desired-operational-characteristics specifications in which different associated parameters, including parameters w₁-wᵣ for the workload characteristics, parameters c₁-cₛ for the configuration characteristics, and parameters o₁-oₜ for the desired operational characteristics, are set to particular values generically represented by the symbols x, y, and z. However, in general, configuration specifications may be more complex. In addition, there may be additional types of specifications included in a distributed-application specifications.

FIG. 18B illustrates deployment of the distributed application within the distributed computer system according to the specification created for the distributed application. FIG. 18B illustrates deployment of a component instance of the distributed application corresponding to the component specification 1809. The specified parameter values are input, in this example, to each of three different deployment/configuration policies 1820-1822, including a storage policy 1820, a network policy 1821, and a hosting policy 1822. The hosting policy is used to configure one or more virtual machines and to deploy and launch the one or more virtual machines within one or more server computers of the distributed computer system. The storage policy is used to allocate storage resources for the component instance and connect the one or more virtual machines to the allocated storage resources, as needed. The network policy is used to embed the one or more virtual machines within local networks, including virtual local networks, with connections to external wide-area networks. The various deployment/configuration policies produce a configuration C 1824 for the component instance that can then be realized via manual, semi-automated, or automated configuration-and-deployment methods. As indicated by expression 1826 in FIG. 18B, the configuration for the component instance of the distributed application can be considered to be composed of configurations generated from each of m different deployment/configuration policies. In certain cases, there may be only a single all-encompassing deployment/configuration policy. In other cases, as in the currently described example, each of multiple deployment/configuration policies generates configurations for different aspects of a component instance of a distributed application, including deploying and configuring one or more virtual machines, allocating storage resources for the one or more virtual machines, and allocating networking resources for the one or more virtual machines.

Use of deployment/configuration policies can significantly facilitate deployment and configuration of distributed applications. For example, once effective, general policies have been devised, the same policies can be used repeatedly, avoiding tedious manual or semi-automated configuration and deployment of distributed applications. In addition, policies can be relatively easily amended or changed, during the operational lifetimes of distributed applications, in order to track changing conditions affecting the performance of the distributed applications, including workload fluctuations, hardware changes, and other conditions. However, while tools for creating and using deployment/configuration policies are available, many managers and administrators fail to use them. One reason that has inhibited widespread adoption of deployment/configuration policies by managers and administrators is that there are many considerations that need to be made in order to create effective deployment/configuration policies, and these considerations often require significant familiarity with distributed-application operational details and configuration details as well as significant familiarity with the resources and resource capacities within the distributed computer system within which the distributed application is deployed. A second, and perhaps more important, reason is that it is difficult for administrators and managers to evaluate the potential performance impacts and other impacts related to updating or changing policies. These impacts may, in some cases, be predictable, but would require a great deal of information about the distributed application, the distributed computer system, and the complex interdependencies between distributed-application configurations and runtime characteristics of the distributed application within the distributed computer system. Trial and error is generally not possible due to the risks associated with policy updates or replacements for currently operational distributed applications and due to the significant overheads incurred with configuring and launching distributed applications.

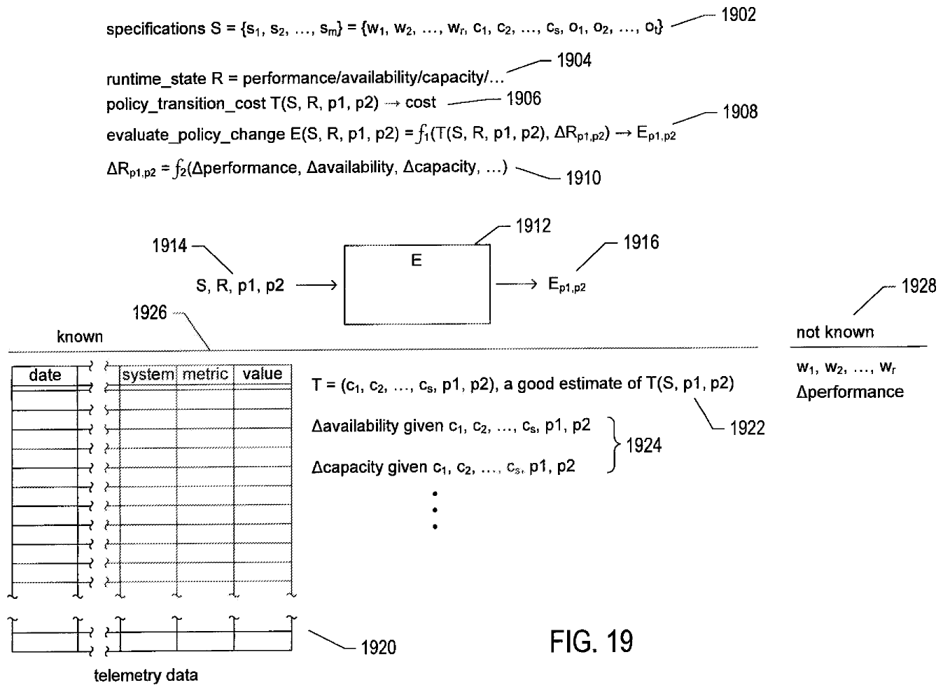

FIG. 19 illustrates a machine-learning-based policy evaluator that addresses the above-mentioned problems associated with use of deployment/configuration policies for deployment and management of distributed applications and other computational entities within distributed computer systems. Expressions 1902 indicates that the specification S for an application, distributed application, distributed-application component, or other computational entity that is to be deployed to a distributed computer system may directly or indirectly include the above-discussed workload characteristics, configuration characteristics, and desired operational characteristics. As mentioned above, the contents of a specification may vary widely depending on implementation and context, but are generalized to facilitate the current discussion. Expression 1904 indicates that the runtime state R for a distributed application or other computational entity includes a number of factors, including performance. resource availability, resource capacity, and other such factors.

The performance of a computational entity is generally indicated by various types of performance metrics that can be obtained from telemetry data collected through system-monitoring interfaces and functionalities. Performance metrics may include computational-throughput metrics, the volume of data transmitted through networks per unit time, data-access rates for data-storage devices, data-access and data-transmission latencies, and other such performance metrics. Similarly, resource availability and resource capacity for an operational computational entity can be obtained from collected telemetry data and/or through operating-system, distributed-operating-system, and/or virtualization-layer interfaces.

Quite often, there are trade-offs between performance, resource availability, resource capacities, and other runtime factor values. For example, one may choose to use mirrored, geographically separated data-storage facilities to ensure high availability and security for the stored data, but use of mirrored geographically separated data-storage facilities may be associated with lowered data-storage capacity, computational overheads, and communications overheads that, in turn, lead to performance impacts. Similar considerations are associated with various levels of redundant-array-of-independent-disk (“RAID”) data-storage technologies. Runtime-state factor values may vary substantially from one distributed-computer system to another, from one virtualization technology to another, and from one operating system to another. As indicated by expression 1906, there is a cost associated with a policy transition from an initial or current policy p1 to a different, new policy p2, referred to as the “target policy.” The transition may occur due to an update made to a current policy, with the updated policy regarded as the target policy, or due to substitution of a new, different target policy for a current policy. The cost is generally a function of the specification S and runtime state R of a computational entity, such as a distributed application, as well as the initial policy p1 and the target policy p2. Costs may include periods of downtime, temporary reductions in performance, impacts to other runtime-state factors, financial costs, and administrative overheads.

As mentioned above, to increase use of deployment/configuration policies, a means for evaluating deployment/configuration policies is needed. As indicated by expression 1908, the deployment/configuration-policy evaluator E can be viewed as a function to which the specifications S, runtime state R, initial policy p1, and target policy p2 are input and which outputs an indication E_{p1,p2} of whether the policy transition is favorable/desirable or unfavorable/undesirable and the degree to which the policy transition is favorable or unfavorable, with the favorability or unfavorability of a policy transition related to the relative effectiveness of the two policies for a particular computational entity. The effectiveness of a policy, in certain cases, can be directly determined from comparing the current runtime state of the computational entity to the desired operational characteristics of the computational entity embodied in the specification S. As one example, a favorable policy transition may be indicated by a positive E_{p1,p2}, an unfavorable policy transition may be indicated by a negative E_{p1,p2}, and the degree of favorability or unfavorability may be indicated by the magnitude of E_{p1,p2}. As also indicated by expression 1908, the deployment/configuration-policy evaluator E may be implemented as a function ƒ₁ of the cost of the policy transition and the change in runtime-state factors values ΔR_{p1,p2} following the policy transition. As indicated by expression 1910, the change in runtime-state factors values ΔR_{p1,p2} can be considered to be a function ƒ₂ of the changes in the values of the various factors that contribute to the runtime state R. For example, the change in runtime-state factor values ΔR_{p1,p2} may be a weighted average of the change in factor values. A single overall value for the changes runtime-state factor values is used, in the current discussion, for simplicity and conciseness. The changes runtime-state factor values may, alternatively, be represented by a set of values changes for the different factors or by other types of numerical representations. The symbols representing policies, runtime-state factor values, configurations, specifications used in the current discussion represent both the data entities that are created through a management or administration interface or compiled from collected data as well as vector encodings of the policies, runtime-state factor values, configurations, specifications that are input to the currently disclosed deployment/configuration-policy evaluator and components within the currently disclosed deployment/configuration-policy evaluator.

Candidate deployment/configuration-policy evaluators needed to address the above-discussed problems associated with deployment/configuration policies would include a machine-learning based implementation 1912 of the above-discussed the deployment/configuration-policy evaluator E, to which the specification S, current runtime state R, initial policy p1, and target policy p2 are input 1914 and which outputs a policy-change favorability indication E_{p1,p2}. A machine-learning based deployment/configuration-policy evaluator would address problems related to the complexities associated with determining the relative effectiveness of different target policies for a particular computational entity based on available data. As discussed above, it is not feasible to experimentally determine the relative effectiveness of different target policies with respect to a computational entity, such as a distributed application, due to the risks and overheads involved in configuring and deploying distributed applications or in updating or changing policies for a currently operational distributed application. The deployment/configuration-policy evaluator E can be modeled as a complex function of the specification S, runtime state R, initial policy p1, and target policy p2, but, as with many such complex functions, the initial policy p1, and target policy p2 are generally far too complex for manual derivation, and can be feasibly determined only by employing machine-learning technologies.

Were the specifications S and the changes in runtime-state factor values ΔR_{p1,p2} for each possible policy transition for a particular computational entity known from experimentally determined data, the deployment/configuration-policy evaluator E could be straightforwardly programmatically implemented for the computational entity, with the policy-change favorability indication Δ_{p1,p2} directly calculated from tabulated experimentally determined data. However, as discussed above, experimental determination of the changes in runtime-state factor values ΔR_{p1,p2} for each possible policy transition for a particular computational entity is not feasible. There is copious telemetry data available for many different types of computational entities operating in different types of distributed computer systems. A machine-learning-based implementation of the deployment/configuration-policy evaluator E that can be trained using the telemetry data would therefore be a practical approach to providing the needed deployment/configuration-policy evaluator E.

As shown in the lower portion of FIG. 19, much of the information needed for training a machine-learning-based deployment/configuration-policy evaluator E is available in telemetry data or can be estimated from telemetry data. The available telemetry data 1920 generally includes performance-metric values, configuration information, and other information related to the configuration and operational status of various computational entities running in different distributed computer systems. In addition, as indicated by expression 1922, a good estimate of the policy-transition cost associated with a transition from a first policy p1 to a second policy p2 can be obtained based on only configuration information for the computational entity and the two policies. As indicated by expressions 1924, the change in values for different runtime-state factors, other than performance, can generally be estimated with a reasonable degree of accuracy given the configuration of a computational entity at the two policies p1 and p2. Thus, this information is shown in a first column 1926 entitled “known” in the lower portion of FIG. 19. However, as indicated in a second column 1928 entitled “not known” in the lower portion of FIG. 19. FIG. 19 indicates that the workload characteristics for the computational entities from which the telemetry data is generated are generally not known, nor does the telemetry data generally include indications of a change in performance-metric values associated with policy transitions. While changes in performance-metric values may be present in certain types of the telemetry data, they are not necessarily correlated with policy changes. Moreover, much of the telemetry data is collected over time periods in which the various policies associated with the computational entities are static. Since the telemetry data is primarily static, with regard to policy changes, the performance impacts of a policy change must somehow be computed or inferred from the telemetry data, but, lacking information about the workloads of the computational entities from which the telemetry data were collected, there is insufficient available information for such computations or inferences. As one example, a target policy that increased the computational bandwidth available to a computational entity with a small workload that is not computational-bandwidth constrained might not result in significant changes to performance metrics such as transactions per second, but for a computational entity with a large workload that is computational-bandwidth constrained, the changes to performance metrics might be quite large. Thus, the directly available telemetry data is insufficient for training a machine-learning-based deployment/configuration-policy evaluator E because there is insufficient information in the telemetry data to generate a policy-change favorability indication E_{p1,p2}.

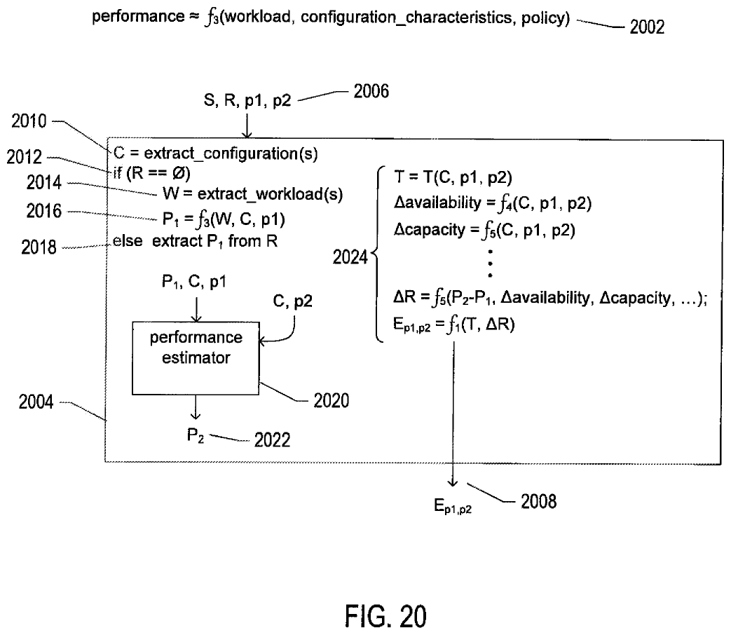

FIG. 20 illustrates one implementation of the currently disclosed deployment/configuration-policy evaluator E. As indicated by expression 2002, the performance for a computational entity can be estimated as a function ƒ₃ of the workload characteristics of the computational entity, the specified configuration characteristics for the computational entity and distributed-computer-system environment in which it runs, and the current policy or policies that control the deployed configuration of the computational entity within the distributed computer system. The fact that performance can be estimated in this fashion leads to the implementation for the currently disclosed deployment/configuration-policy evaluator E 2004 shown in FIG. 20. The machine-learning-based deployment/configuration-policy evaluator 2004 receives 2006 the specification S and, optionally, the current runtime state R of a computational entity, such as a distributed application, along with a first, current policy or policies p1 and a second policy or policies p2. The machine-learning-based deployment/configuration-policy evaluator 2004 outputs 2008 a policy-change favorability indication E_{p1,p2} indicating whether or not a change in policy from p1 to p2 would be favorable or desirable. The machine-learning-based deployment/configuration-policy evaluator 2004 can be used to determine the favorability of a policy transition for a currently operating computational entity, in which case the current runtime state R is input to the machine-learning-based deployment/configuration-policy evaluator, can be used to determine the favorability of a hypothetical policy transition for a an undeployed computational entity, in which case no runtime state R is input to the machine-learning-based deployment/configuration-policy evaluator.

The machine-learning-based deployment/configuration-policy evaluator 2004 first extracts specified configuration characteristics C from the specifications S 2010. The machine-learning-based deployment/configuration-policy evaluator then determines 2012 whether or not a runtime state R has been input. If a runtime state R has not been input, the machine-learning-based deployment/configuration-policy evaluator 2004 extracts workload characteristics W from the input specifications S 2014 and then uses the above-mentioned function ƒ₃ to generate an estimated initial performance P₁ for the computational entity 2016. Otherwise, when a runtime state R has been input, the machine-learning-based deployment/configuration-policy evaluator determines the initial performance P₁ from the input runtime state R 2018. Next, the initial performance P₁, configuration characteristics C, and the policy or policies p1 are input to a first stage of a machine-learning-based performance estimator 2020, the configuration characteristics C and the target policy or policies p2 are input to a second stage of the machine-learning-based performance estimator, and the machine-learning-based performance estimator outputs an estimate of the performance P₂ 2022 of the computational entity were the initial policy or policies p1 replaced by the target policy or policies p2. Then, as indicated by expressions 2024, the policy-transition cost T is estimated, as discussed above, the changes in the runtime-state factor values, other than the performance factor, or estimated, as also discussed above, the changes in runtime-state factor values ΔR_{p1,p2} are computed using the above-discussed function ƒ₂ and the performance difference P₂−P₁, the policy-change favorability indication E_{p1,p2} is computed using the above-discussed function ƒ₁, and, finally, the policy-change favorability indication E_{p1,p2} is output by the machine-learning-based deployment/configuration-policy evaluator 2004. The computations represented by expressions 2024 may be programmatically computed or, alternatively, the input specifications S, runtime state R, and policies p1 and p2 along with the performance values P₁ and P₂ may be fed into one or more machine-learning-based function implementations that produce the policy-change favorability indication EΔR_{p1,p2}.

The machine-learning-based performance estimator 2020 is a significant component within the machine-learning-based deployment/configuration-policy evaluator that allows the machine-learning-based deployment/configuration-policy evaluator to be trained using telemetry data collected from various computational entities running within various distributed computing systems. The machine-learning-based performance estimator, as further discussed below, can be trained using the telemetry data lacking workload characteristics and performance-metric-value changes associated with policy transitions. Once the machine-learning-based performance estimator is trained, the remaining computations needed by the deployment/configuration-policy evaluator to produce a policy-change favorability indication E_{p1,p2} can be made using the above-discussed estimates of the changes to the values of non-performance runtime-state factors and the policy-transition cost.

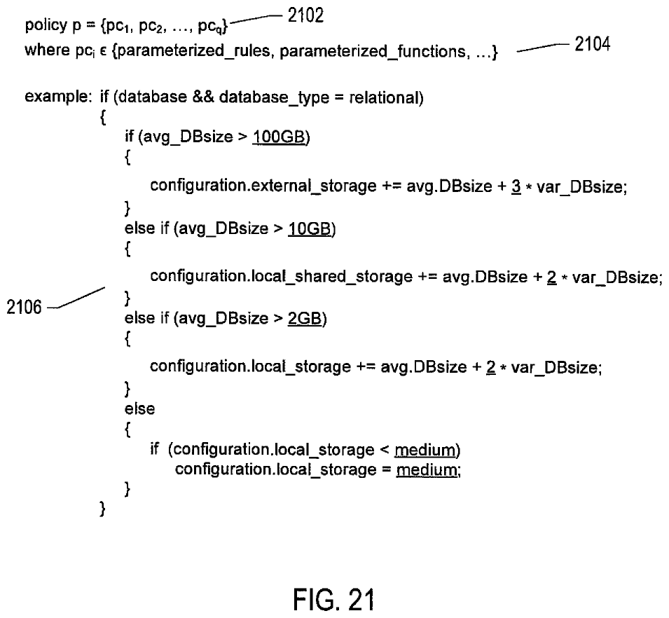

FIG. 21 illustrates the meaning of the term “policy” in the current document. As indicated by expression 2102, a policy p is a set of policy components pc₁, pc₂, . . . , pc_{q}, where q is the number of policy components in policy p. As indicated by expression 2104, a policy component may be one or more parameterized rules, one or more parameterized functions, or other parameterized entities from which configurations can be obtained. A portion of an exemplary parameterized function 2106 is provided in FIG. 21. Various parameters within the set of conditional statements are underlined. In the example portion of a policy function, configurations for data storage are updated based on the various parameter values. As discussed above, policies can be used to control deployment and configuration of computational entities within a distributed computer system according to specified configurations. For example, if the specified configuration calls for access to a relational database, then, depending on the estimated amount of data that will be maintained within the database, the distributed application or distributed-application instance can be properly provisioned with the needed data-storage capacities. In essence, a policy translates a specified configuration for a computational entity into a plan for allocating distributed-computer-system resources from the distributed computer system with sufficient capacities to support execution of the distributed application or distributed-application instance.

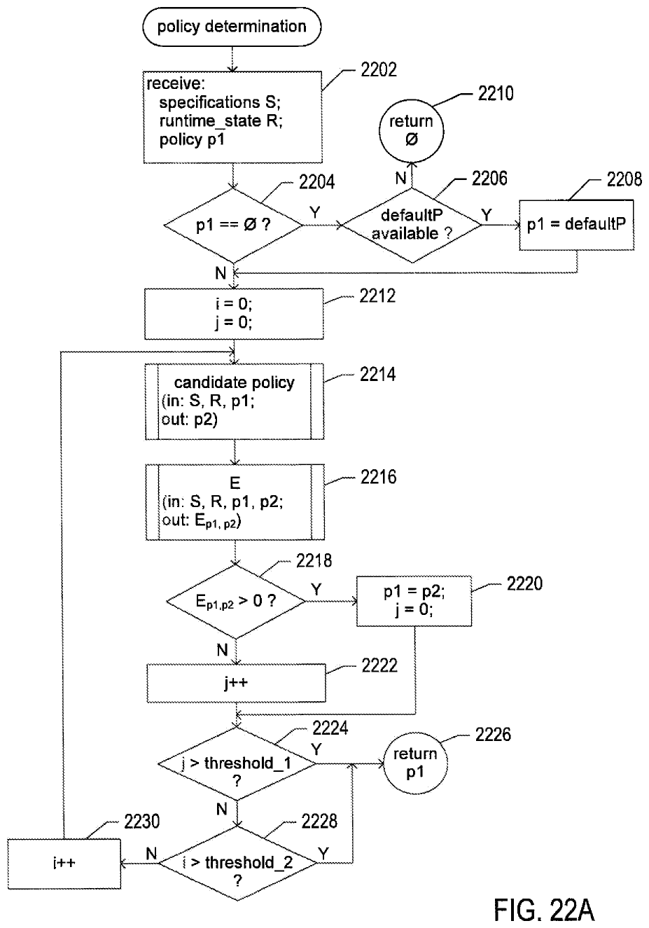

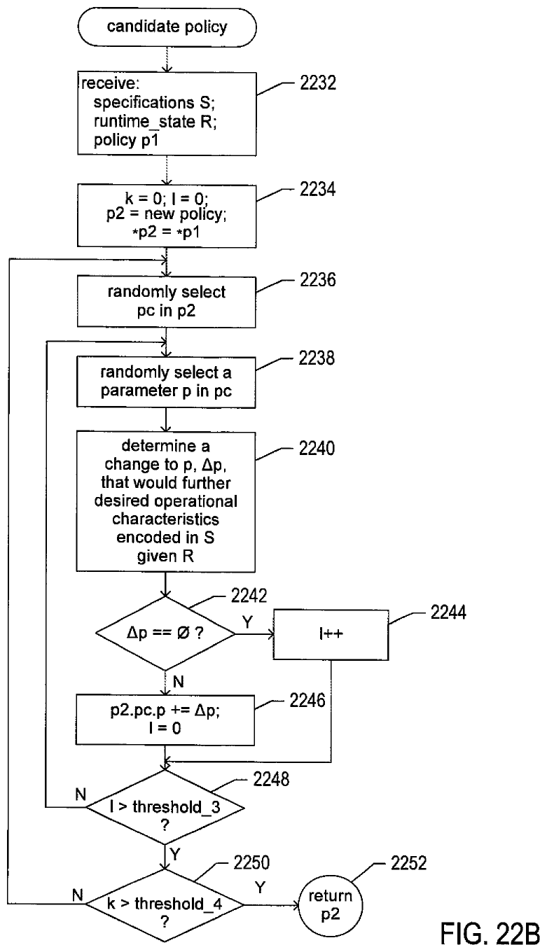

FIGS. 22A-B provide control-flow diagrams that illustrate use of the currently disclosed deployment/configuration-policy evaluator to determine a better policy for a currently running distributed application. FIG. 22A provides a control-flow diagram for a routine “policy determination” that attempts to determine a better policy for control of the distributed application. In step 2202, the routine “policy determination” receives the specifications S, runtime state R, and current policy or policies p1 for the distributed application. When no current policy is supplied, as determined in step 2204, and when a default initial policy is available, as determined in step 2206, the initial policy p1 is set to the default initial policy in step 2208. Otherwise, the routine “policy determination” returns some type of error value in step 2210. In step 2212, local variables i and j are both set to 0. In step 2214, a routine “candidate policy” is called to select a candidate policy p2 for evaluation. In step 2216, the currently disclosed deployment/configuration-policy evaluator is called to generate a policy-change favorability indication E_{p1,p2}. When the policy-change favorability indication is positive, as determined in step 2218, then, in step 2220, p1 is set to the candidate policy p2 and local variable j is set to 0. Otherwise, local variable j is incremented, in step 2222. When local variable j is greater than a threshold value, as determined in step 2224, the routine “policy determination” returns policy p1 in step 2226. Thus, local variable j is used to detect more than a threshold number of failures to find a better candidate policy. Otherwise, when local variable i is greater than a threshold value, as determined in step 2228, the routine “policy determination” returns policy p1. Local variable i is used to discontinue the search for better policies after a threshold number of iterations of the loop that begins with step 2214. Otherwise, local variable i is incremented, in step 2230 followed by return of control to step 2214 for a next iteration of the loop that begins with step 2214.

FIG. 22B provides a control-flow diagram for the routine “candidate policy,” called in step 2214 of FIG. 22A. In step 2232, the routine “candidate policy” receives the specifications S, runtime state R, and current policy or policies p1 for the distributed application. In step 2234, the routine “candidate policy” sets two local variables k and l to 0. sets local variable p2 to a newly allocated policy, and then copies policy p1 into policy p2. Step 2236 begins a loop in which policy components are randomly selected for alteration. In step 2236, a policy component pc and policy p2 is randomly selected. In step 2238, a parameter p within the currently considered policy component is randomly selected. In step 2240, the routine “candidate policy” determines a change to the currently considered parameter p, Δp, that would lead to more desired operational characteristics for the distributed application given the current runtime state and the desired operational characteristics encoded in the specifications S. If no such change appears to be possible, as determined in step 2242, the local variable l is incremented, in step 2244. Otherwise, in step 2246, the currently considered parameter is modified by Δp and local variable l is set to 0. When local variable l is less than or equal to a threshold value, as determined in step 2248, control flows back to step 2238 in order to attempt to modify an additional parameter within the currently considered policy component. Otherwise, when local variable k is greater than a threshold value, as determined in step 2250, the routine “candidate policy” returns policy p2 in step 2252. Otherwise, control flows back to step 2236 for an additional attempt to select a policy component for alteration.

The routine “policy determination” embodies a very simple method for attempting to alter a current policy controlling a currently operational distributed application in order to better achieve the specified operational characteristics for the distributed application. Much more sophisticated approaches that involve gradient-descent or other optimization techniques could alternatively be used for more optimal policy alteration. However, in all cases, the currently disclosed deployment/configuration-policy evaluator is necessary for evaluating candidate target policies without needing to actually transition the currently running distributed application to the candidate target policies in order to evaluate their effects. The currently disclosed deployment/configuration-policy evaluator thus provides a risk-free approach to policy evaluation that, in turn, facilitates use of policies by managers and administrators to control configuration of distributed applications. Since the currently disclosed deployment/configuration-policy evaluator can generate policy-change favorability indications even without input of a runtime state, the currently disclosed deployment/configuration-policy evaluator can also be used to facilitate de novo creation of policies by manual, semi-automated, or automated policy-creation techniques. In this way, the currently disclosed deployment/configuration-policy evaluator directly addresses the above-identified problems that inhibit use of policies for configuration and deployment of distributed applications and other computational entities by managers and administrators.

As mentioned above, a significant component of the currently disclosed deployment/configuration-policy evaluator is a machine-learning-based performance estimator. A discussion of the implementation of the machine-learning-based performance estimator, which occurs in the final subsection of this document, requires background information related to autoencoders, variational autoencoders, and conditional variational autoencoders, discussed in the next subsection.

### Autoencoders, Variational Autoencoder, and Conditional Variational Autoencoders

FIG. 23 illustrates a simple autoencoder. The simple autoencoder is a 3-layer neural network that includes an input layer 2302, a hidden layer 2303, and an output layer 2304. A vector x 2306 is input to the simple autoencoder and a vector x′ 2308 is output from the simple autoencoder. The simple autoencoder is trained by inputting a set of vectors {x₁, x₂, . . . , xₓ} to the simple autoencoder and backpropagating a squared-difference loss 2310. This results in the simple autoencoder learning to output, in response to an input vector x, an output vector x′ as similar as possible to the input vector x. Of course, simply learning the identity function by the simple autoencoder would serve no particular purpose. However, because the hidden layer has fewer nodes than the output and input layers, the simple autoencoder is directed, by backpropagation, to learn to abstract significant features from the input vector from which the input vector can be regenerated by the output layer. In essence, the simple autoencoder learns something similar to the results of principal component analysis. As those with knowledge of modern data analysis will recognize, principal component analysis is a very useful tool for decreasing the complexity of data sets to facilitate data analysis. In another sense, the simple autoencoder is trained to carry out lossy data compression on the input vectors, which is also a valuable operation. The simple autoencoder shown in FIG. 23 receives input vectors and outputs output vectors of dimension 8, with each element including a value from 0 two 255, as indicated by expression 2312. The input layer has dimension 3, as indicated by expression 2314. Thus, 8-dimensional vectors are mapped into a 3-dimensional latent space represented by the hidden layer. To output an output vector, the simple autoencoder maps a 3-dimensional latent-space point back to an 8-dimensional space. The input operation is represented by expression 2316, where g is a column vector of activation functions 2318. W is a matrix of weights 2320, and b is a column vector of scalars corresponding to the term aₒwₒ in the expression shown in input layer 1136 of FIG. 11. The output operation is represented by expression 2322, where g′ is a column vector of activation functions 2324. W′ is a matrix of weights 2326, and b is a column vector of scalars. Autoencoders are used extensively in modern technologies and are often embedded in larger feed-forward neural networks.

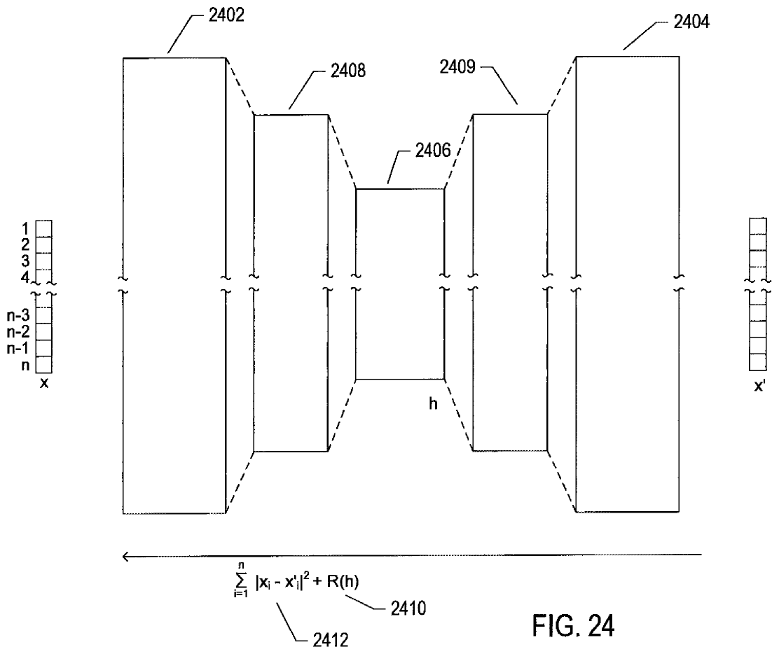

FIG. 24 illustrates more complex autoencoders. More complex autoencoders may include input 2402 and output 2404 layers comprising multiple node layers as well as hidden layers 2406 comprising multiple node layers. In addition, certain more complex autoencoders may include additional intermediate layers 2408-2409. Multi-node layers and additional intermediate layers can often be trained with significantly smaller training data sets and can often achieve less lossy data compression/decompression and more precise feature extraction. While using hidden layers with lower dimensionality than the input and output layers provides a constraint to force an autoencoder to learn to carry out feature extraction, another approach is to include a regularization term 2410 in addition to the reconstruction term 2412 in the loss function that is backpropagated to train the autoencoder. An appropriate reconstruction term can be used to constrain an autoencoder to carry out feature extraction even when the hidden layer has the same dimensionality as the input and output layers. Moreover, a reconstruction term can also be used as a further constraint in an autoencoder in which the hidden layer has lower dimensionality than the input and output layers.

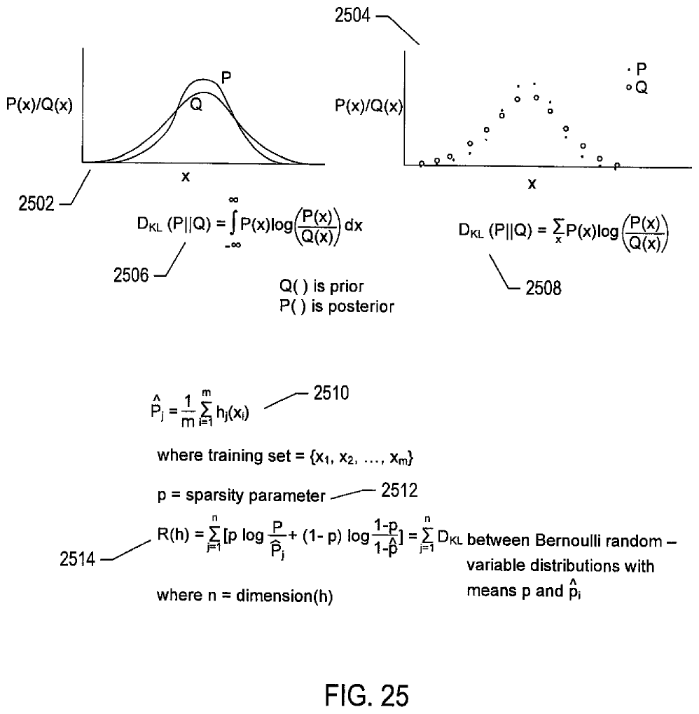

FIG. 25 illustrates use of the Kullback-Leibler divergence as a regularization term. The Kullback-Leibler divergence (“D_{KL}”) is a generated value that indicates the dissimilarity between two probability distributions. Two continuous probability distributions, P and Q, are shown in plot 2502 and two corresponding discrete probability distributions are shown in plot 2504. Expression 2506 represents the D_{KL} for the two continuous probability distributions and expression 2508 represents the D_{KL} for the two discrete probability distributions. The D_{KL} is always greater than or equal to 0, with larger values indicating decreasing similarity between the two probability distributions from which the D_{KL} is generated. The D_{KL} value is asymmetric with respect to the two compared probability distributions. This can easily be seen by the fact that, in expressions 2506 and 2508, the probability P(x) occurs twice in the integrated or summed expression while the probability Q(x) occurs only once. In many cases, the probability distribution Q is a theoretical distribution while the probability distribution P is either an observed probability distribution or a probability distribution computed based on additional information. In Bayesian terms, the probability distribution Q is the prior distribution and the probability distribution P is the posterior distribution. The D_{KL} value, also referred to as the “relative entropy,” is a measure of the information gained by revising one's beliefs from the prior distribution Q to the posterior distribution P. This is equivalent to the amount of information last when Q is used to approximate P.

As shown by expression 2510, the average activation of the hidden-layer node j, \hat{p}ⱼ, is the sum of the input values that triggered activation of the hidden-layer node j in a training set of m input vectors. A sparsity parameter p close to zero is defined, as indicated by expression 2512. Using the sparsity parameter and the average hidden-layer node activations, a regularization term is computed, as indicated by expression 2514, which is equivalent to the sum of the D_{KL}, values for Bernoulli random-variable distributions with means p and \hat{p}ⱼ. The regularization term forces the hidden layer to be sparsely activated, which results in a nonuniform distribution of input vector mappings to the latent space, often referred to as “clustering.”

Trained autoencoders are often used generatively, i.e. to generate output vectors based on the contents of the hidden-layer latent space. For example, if the input vectors used to train the autoencoder correspond to images of a certain type of object, then selecting points in the latent space and decoding them through the output layer will produce various different alternative images of the certain type of object. A generative use of an autoencoder can, for example, produce simulated data sets.

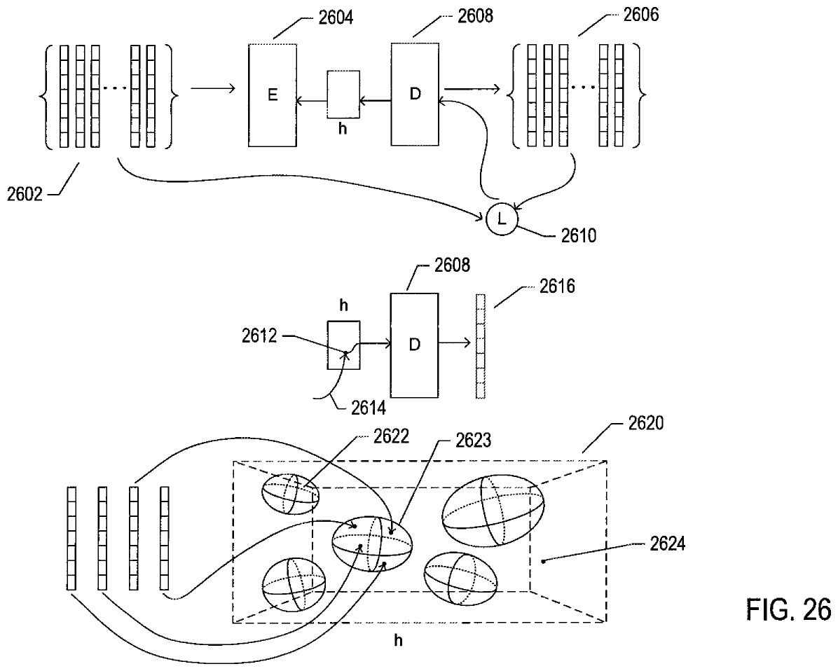

FIG. 26 illustrates generative use of an autoencoder as well as a serious problem related to generative use of an autoencoder. At the top of FIG. 26, training of an autoencoder is diagrammatically represented. The set of training data 2602 is input to the encoder portion of the auto encoder 2604 to generate corresponding output data 2606 produced by the decoder layer 2608 of the autoencoder. The input and output data are used together to generate losses 2610 that are backpropagated into the autoencoder. Then, a point 2612 is sampled from the latent space, as indicated by arrow 2614, and the corresponding vector is input to the decoder layer 2608 of the autoencoder to generate an output vector 2616 similar to the input vectors used to train the autoencoder. The latent space is represented in FIG. 26 as a 3-dimensional space 2620. Due to the hidden-layer-dimensionality constraint and/or regularization constraints, input training vectors end up being mapped nonuniformly within the latent space. The mapping is generally made to particular regions of the latent space, such as regions 2622-2623, represented by ellipsoids in FIG. 26. These particular regions represent clusters within the latent space to which the input vectors are mapped. These clusters, in turn, represent regions of the latent space corresponding to features. The problem with the generic autoencoder so far discussed is that a person or automated routine attempting to generate simulated data is unaware of the locations of the feature regions in the latent space. Instead, users would generally randomly sample the latent space in order to generate simulated data. However, if a user selects a point outside of the cluster regions, such as point 2624 in the latent space 2620, the decoder portion of the autoencoder has no information regarding how to map that point in latent space back to the data space, since the decoder layer has not encountered such points during training.

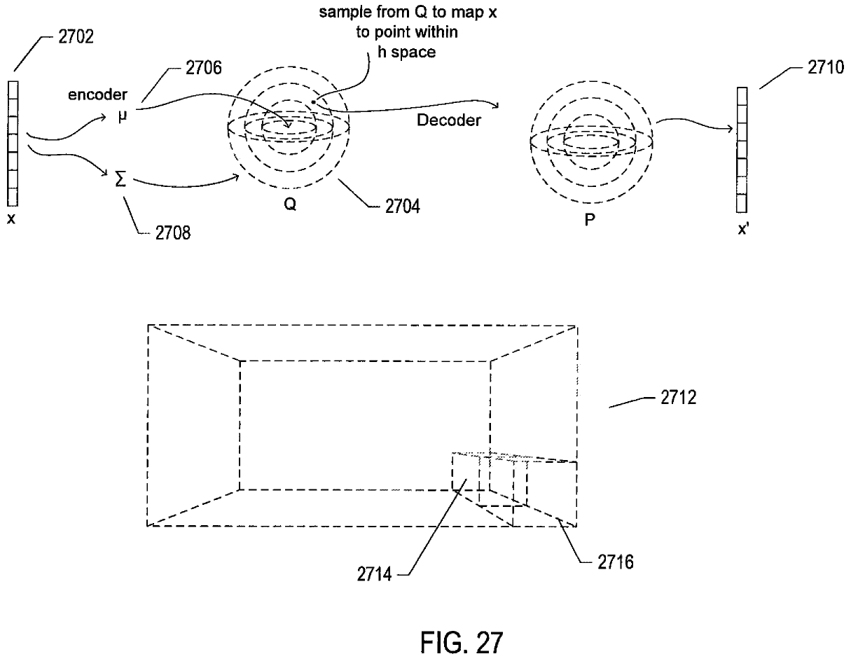

FIG. 27 illustrates a solution to the problem with generative use of autoencoders discussed in the preceding paragraph of this document. The solution is incorporated into a different type of autoencoder referred to as a “variational autoencoder.” In this approach, an input vector 2702 is probabilistically mapped, via a learned probability distribution Q, to a point within a region 2704 of the latent space rather than directly mapped to a particular point in latent space. This is done by generating, from the input vector 2702, a vector representing a mean point 2706 and the covariant matrix 2708 for a normal isotropic distribution about the mean point with a fixed variance. The main point and covariant matrix are analogous to a mean value and scalar variance for a 1-dimensional probability distribution. The mean point and covariant matrix basically parameterize the probability distribution Q for the input vector. Then, the variational autoencoder selects a point from the region of the latent space 2704 using the probability distribution Q as the encoding z of the input vector and forwards that encoding to the decoder. The decoder has learned a probability distribution P corresponding to probability distribution Q and uses probability distribution P to probabilistically generate an output vector 2710 from the encoding z. A variational autoencoder therefore tends to spread mappings of input vectors throughout the latent space. As shown in plot 2712 in FIG. 27, the latent space in a trained variational autoencoder includes latent-space regions, such as latent-space regions 2714 and 2716, that represent clustering of training data, as in the latent space for a simple autoencoder 2620 shown in FIG. 26, but the latent-space regions produced within a variational autoencoder are closely packed together within the latent space so that, in general, any point selected from the latent space can be probabilistically decoded by the decoder of the variational autoencoder to produce a reasonable output vector.

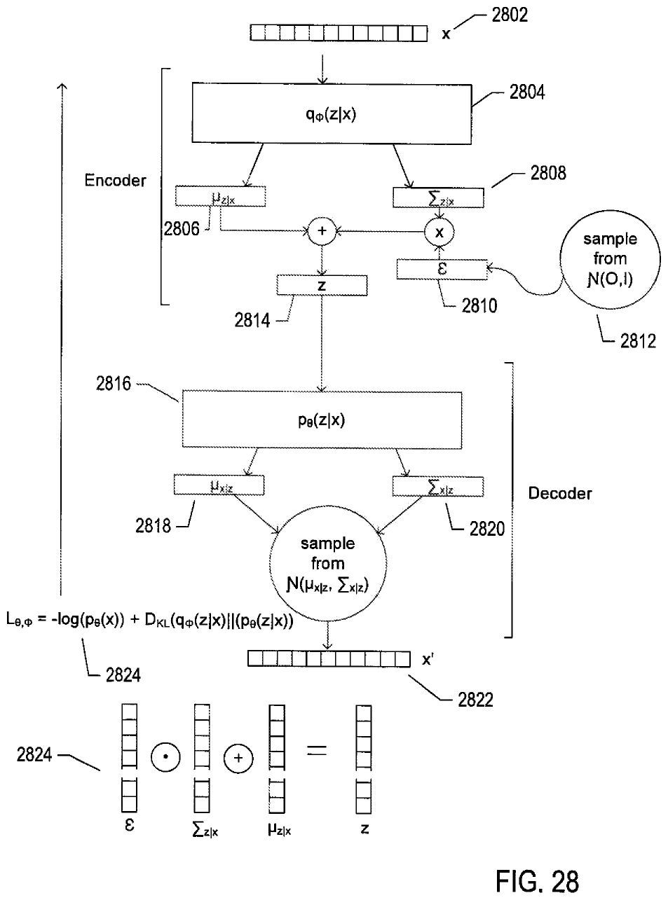

FIG. 28 illustrates the architecture of a variational autoencoder. An input vector 2802 is input to the encoder portion of the variational autoencoder 2804, which has learned the conditional probability distribution Q_{ϕ}(z|x). The subscript ϕ represents the node-weights parameterization of the conditional probability distribution implemented by the encoder portion of the variational autoencoder. The input vector x is thus mapped to a mean point μ_{(z|x)} 2806 and a multi-dimensional variance Σ_{(z|x)} 2808. A point represented by a vector ε 2810 is sampled from a normal isotropic probability distribution 2812, multiplied by multi-dimensional variance Σ_{(z|x)} 2808, and the product of the multiplication is added to mean point μ_{(z|x )} 2806 to produce an encoding of the input vector z 2814. The encoding z is input to the decoder portion of the variational autoencoder 2816 which has learned the conditional probability distribution P₀(x|z). The decoder uses the conditional probability distribution P_{θ}(x|z) to generate a mean point μ_{(x|z)} and a multi-dimensional variance Σ_{(x|z)} 2820. The subscript θ represents the node-weights parameterization of the conditional probability distribution implemented by the decoder portion of the variational autoencoder. The decoder than selects a point from a normal isotropic probability distribution within the data space characterized by the mean point μ_{(x|z)} multi-dimensional variance Σ_{(x|z)} and outputs output vector 2822 corresponding to the selected point. The variational autoencoder, during training, backpropagates losses generated by a loss function such as loss function 2024, which includes both reconstruction and regularization terms. Generation of the encoding z by the encoder portion of the variational autoencoder is diagrammatically represented by expression 2824 in the lower portion of FIG. 28.

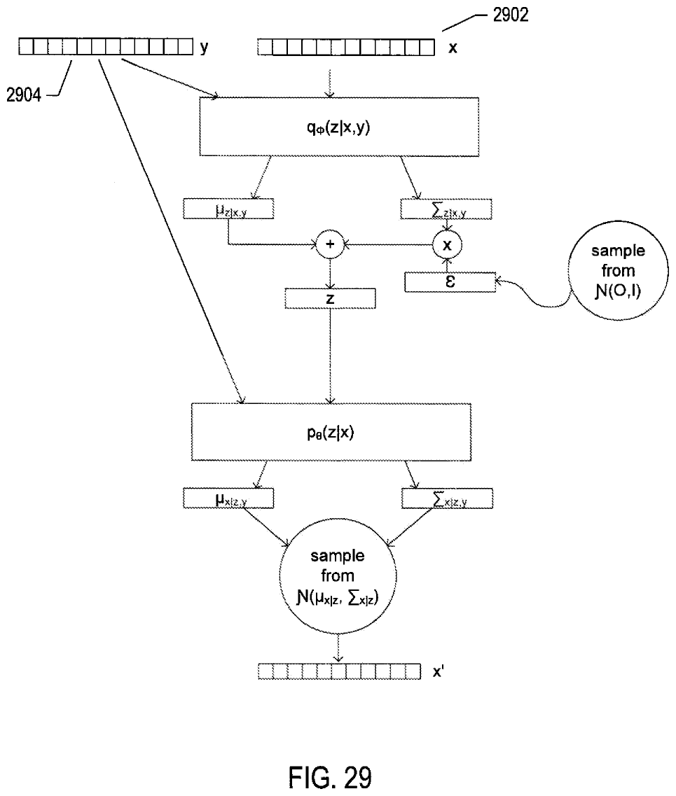

FIG. 29 illustrates yet another type of autoencoder referred to as a “conditional variational autoencoder.” The architecture of the conditional variational autoencoder is quite similar to that of the variational autoencoder, shown in FIG. 28. The major difference between the conditional variational autoencoder and the variational autoencoder is that the encoder portion of the conditional variational autoencoder receives, in addition to an input vector 2902, a label 2904. The label is essentially a category or type associated with the input vector. The label is also input to the decoder portion of the conditional variational autoencoder. Input of the label along with the input vector, during training, results in the encoder portion of the conditional variational autoencoder learning the conditional probability Q_{ϕ}(z|x, y) rather than the conditional probability distribution Q_{ϕ}(z|x) learned by the encoder portion of the variational autoencoder. Similarly, the decoder portion of the conditional variational autoencoder learns the conditional, probability distribution P_{θ}(x|z, y) rather than the conditional probability distribution P_{θ}(x|z) learned by the decoder portion of the variational autoencoder. The conditional variational autoencoder thus associates labels with latent-space regions corresponding to clusters. This allows particular types of sample data to be generated from the latent space and decoder portion of the conditional variational autoencoder.

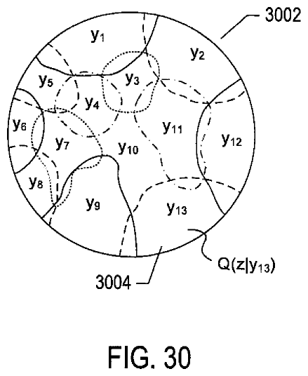

FIG. 30 provides a 2-dimensional representation of the latent space of a conditional variational autoencoder. The latent space 3002 is partitioned into cluster or feature regions, each cluster or feature region associated with a label. Thus, for example, cluster or feature region 30 is associated with the label y₁₃ and represents the conditional probability distribution Q_{ϕ}(z|y₁₃). Thus, the conditional variational autoencoder learns to map input vector/label pairs to labeled cluster or feature regions of the latent space.

### Additional Details Regarding the Currently Disclosed Methods and Systems for Policy Evaluation

FIG. 31 illustrates the performance-estimator component (2020 in FIG. 20) of the currently disclosed deployment/configuration-policy evaluator. In the upper portion of FIG. 31, the performance-estimator component 3102 is shown to be a conditional variational autoencoder that receives, as input, a performance P value 3104 and a label 3106 comprising a concatenation of a configuration C and a policy p. During training, the same label is input to the decoder portion 3108 of the conditional variational autoencoder. As discussed above with reference to expression 2002 in FIG. 20, the performance for a distributed application, microservice, or distributed-application components can be estimated from the workload, configuration characteristics, and current policy. During training, therefore, the conditional variational autoencoder 3102 that implements the performance-estimator component learns to estimate workload characteristics from the input performance and label in order to generate an output performance value, similar to the input performance value, from the internal encoding of the input performance vector.

Once the performance-estimator component has been trained, it is used within the deployment/configuration-policy evaluator as shown 3110 in the lower portion of FIG. 31. When used as the performance-estimator component of the deployment/configuration-policy evaluator, the conditional variational autoencoder 3110 receives, as input, a performance value, a current policy p1 3112, and a label 3114 comprising the configuration characteristics C and current policy p1. However, the decoder portion of the conditional variational autoencoder 3116 receives, as input, the internal encoding z 3118 of the input vector and a different label 3120 comprising the same configuration characteristics C and the target policy p2. As a result, the decoder portion of the conditional variational autoencoder produces an estimate of the performance of a distributed application or distributed-application component with configuration C and target policy p2. These are the inputs and outputs discussed above. with reference to FIG. 20, of the performance-estimator component of the currently disclosed deployment/configuration-policy evaluator. It should be noted that this is a new and different use of conditional variational autoencoders. In the currently disclosed deployment/configuration-policy evaluator, the performance-estimator component is implemented as a conditional variational autoencoder so that the conditional variational autoencoder can learn workload information missing from the training data set.

The currently disclosed performance-estimator component is a specific example of a more general class of machine-learning-based data-point predictors/estimators that learn workload characteristics of computational entities from data collected from the computational entities during operation of the computational entities. The more general class of machine-learning-based data-point predictors/estimators have many uses in administration and management tools as well as in other types of tools and systems. In the general case, machine-learning-based data-point predictors/estimators receive vectors of encoded values derived from data collected during operation of computational entities, where the encoded values are functionally dependent on the workload characteristics of the computational entities. They also receive labels constructed from data collected during operation of the computational entities that is not functionally dependent on the workload characteristics of the computational entities and that represent types or classes of computational entities. The machine-learning-based data-point predictors/estimators output estimates of data points or predictions of data points for computational entities associated with different labels, where the predictions or estimates depend on learning, by the machine-learning-based data-point predictors/estimators, how to determine workload characteristics of a computational entity from the input vectors of encoded values and labels. Data-point prediction and estimation have many uses in modern technology, including generating simulated data, estimating various types of metric values from partial information contained in data sets, and other uses.

The present invention has been described in terms of particular embodiments, it is not intended that the invention be limited to these embodiments. Modifications within the spirit of the invention will be apparent to those skilled in the art. For example, any of many different implementations of the currently disclosed deployment/configuration-policy evaluator can be obtained by varying various design and implementation parameters, including modular organization, control structures, data structures, hardware, operating system, and virtualization layers, automated orchestration systems, virtualization-aggregation systems, and other such design and implementation parameters. For example, different numbers of node layers can be used for encoder, decoder, and hidden-layer portions of the conditional variational autoencoder. As mentioned above, many different types of encodings of configuration characteristics, performance values, and policies can be used to generate input and output vectors for the performance-estimator component of the currently disclosed deployment/configuration-policy evaluator. Different types of evaluator outputs are also possible. In one implementation of the currently disclosed performance-estimator components, the conditional variational autoencoder produces three different performance-value output vectors, as indicated by the dashed output 3124 in FIG. 31 rather than a single performance-value output. The performance assessments are then selected by sampling the three different performance-value outputs. This facilitates determination of error bounds for the performance-estimator component and for the currently disclosed deployment/configuration-policy evaluator, as a whole. Additionally, different types of loss functions can be used for training the conditional variational autoencoder that implements the performance-estimator component.

1. A machine-learning-based data-point predictor/estimator that learns workload characteristics of computational entities from stored data collected during operation of the computational entities and uses the learned workload characteristics to generate output points in a data space, from received input points in the data space, that represent useful predictions and/or estimations, the machine-learning-based system component comprising:
an encoder layer, comprising one or more neural-network-node layers, that receives a first vector of encoded values contained in, or derived from, the stored data collected during operation of a computational entity, the first vector representing a point in the data space, and that outputs a vector corresponding to a latent-space point within a first distribution of latent-space points conditionally dependent on workload characteristics of the computational entity;
a hidden layer comprising one or more neural-network-node layers that receives the vector corresponding to a latent-space point and outputs the vector to a decoder layer; and
the decoder layer comprising one or more neural-network-node layers that receives the vector corresponding to the latent-space point and outputs a second vector of encoded values, representing a point in the data space, based on a second distribution of data-space points conditionally dependent on the workload characteristics of the computational entity.

2. The machine-learning-based data-point predictor/estimator of claim 1 wherein, during operation.
the encoder layer receives, in addition to the first vector of encoded values, a first label comprising a second vector of encoded values contained in, or derived from, the stored data collected during operation of a computational entity and a third vector of encoded values contained in, or derived from, the stored data collected during operation of the computational entity and outputs a vector corresponding to a latent-space point within a first distribution of latent-space points conditionally dependent both on the workload characteristics of the computational entity and on the first label; and
the decoder layer receives the vector corresponding to the latent-space point and a second label comprising the second vector of encoded values and a fourth vector of encoded values contained in, or derived from, the stored data collected during operation of the computational entity and outputs a second vector of encoded values, representing a point in the data space, based on a second distribution of data-space points conditionally dependent both on the workload characteristics of the computational entity and on the second label.

3. The machine-learning-based data-point predictor/estimator of claim 1 wherein, during training.
the encoder layer receives, in addition to the first vector of encoded values, a label comprising a second vector of encoded values contained in, or derived from, the stored data collected during operation of a computational entity and a third vector of encoded values contained in, or derived from, the stored data collected during operation of the computational entity and outputs a vector corresponding to a latent-space point within a first distribution of latent-space points conditionally dependent both on the workload characteristics of the computational entity and on the first label; and
the decoder layer receives the vector corresponding to the latent-space point and the label and outputs a second vector of encoded values, representing a point in the data space, based on a second distribution of data-space points conditionally dependent both on the workload characteristics of the computational entity and on the label.

4. The machine-learning-based data-point predictor/estimator of claim 3 wherein, during training, the second vector of encoded values output by the decoder layer is used, along with the input first vector of encoded values, to generate a loss computed from reconstruction and regularization terms that is backpropagated into the machine-learning-based data-point predictor/estimator.

5. A machine-learning-based policy evaluator comprising:
computer instructions that, when executed by one or more processors of a computer system including the one or more processors and one or more memories, at least one of which stores the computer instructions, control the computer system to
receive a specification, an initial policy, and a target policy,
optionally receive a runtime state, and
output a policy-change favorability indication;
a machine-learning-based performance estimator that produces an estimate of the performance of a computational entity based on learned workload characteristics, corresponding to the received specification, controlled by the target policy; and
a policy-change-favorability-indication generator that uses the performance estimate produced by the machine-learning-based performance estimator to generate the policy-change favorability indication output by the machine-learning-based policy evaluator.

6. The machine-learning-based policy evaluator of claim 5 wherein the initial policy and target policy each comprises one or more policy components that together specify resource allocation, configuration, and deployment of a computational entity to a distributed computer system.

7. The machine-learning-based policy evaluator of claim 6 wherein computational entities include distributed applications, microservices, and distributed-application components.

8. The machine-learning-based policy evaluator of claim 6
wherein the specification received by the machine-learning-based policy evaluator includes configuration and deployment specifications and target operational characteristics; and
wherein the specification received by the machine-learning-based policy evaluator includes one or more of
workload characteristics, and
information from which workload characteristics can be derived.

9. The machine-learning-based policy evaluator of claim 8 wherein the runtime state optionally received by the machine-learning-based policy evaluator includes indications of runtime-state factors, including:
computational-entity performance;
resource capacities; and
resource availabilities.

10. The machine-learning-based policy evaluator of claim 9 wherein the policy-change-favorability-indication generator generates the policy-change favorability indication output by:
estimating a policy-transition cost using a specified configuration derived from the received specification, initial policy, and target policy;
estimating changes in non-performance runtime-state factor values resulting from a transition from the initial policy to the target policy;
receiving a performance estimate from machine-learning-based performance estimator;
when a runtime state is received by the machine-learning-based policy evaluator, extracting an initial performance from the received runtime state;
when a runtime state is not received by the machine-learning-based policy evaluator, computing an initial performance from the received specification and initial policy;
computing a change in the performance runtime-state-factor value using the received performance estimate and the initial performance; and
using the policy-transition cost, estimated changes in non-performance runtime-state factor values, and computed change in the performance runtime-state-factor value to generate the policy-change favorability indication.

11. The machine-learning-based policy evaluator of claim 10
wherein the policy-change favorability indication is a signed numerical value;
wherein, when the policy-change favorability indication is positive, the policy-change favorability indication indicates that a policy transition from the initial policy to the target policy would result in a runtime state associated with operational characteristics closer to the target operational characteristics;
wherein, when the policy-change favorability indication is negative, the policy-change favorability indication indicates that a policy transition from the initial policy to the target policy would result in a runtime state associated with operational characteristics that differ more from the target operational characteristics; and
wherein the magnitude of the policy-change favorability indication indicates the magnitudes of the predicted changes in the operational characteristics associated with the resulting runtime state.

12. The machine-learning-based policy evaluator of claim 9 wherein the machine-learning-based performance estimator is a conditional variational autoencoder.

13. The machine-learning-based policy evaluator of claim 12 wherein, during operation of the machine-learning-based policy evaluator;
an encoder portion of the conditional variational autoencoder receives a computed or derived initial performance value and a label comprising a specified configuration and the initial policy;
a decoder portion of the conditional variational autoencoder receives an encoding of the initial performance output by the encoder portion of the conditional variational autoencoder and a label comprising the specified configuration and the target policy; and
the decoder portion of the conditional variational autoencoder outputs an estimated performance value following a policy transition from the initial policy to the target policy.

14. The machine-learning-based policy evaluator of claim 12 wherein, during training of the machine-learning-based policy evaluator;
an encoder portion of the conditional variational autoencoder receives a computed or derived initial performance value and a label comprising a specified configuration and the initial policy;
a decoder portion of the conditional variational autoencoder receives the encoding of the initial performance output by the encoder portion of the conditional variational autoencoder and the label comprising the specified configuration and the initial policy; and
the decoder portion of the conditional variational autoencoder outputs an estimated performance value that is used to generate a loss that is backpropagated into the conditional variational autoencoder.

15. A method for generating a new policy that controls deployment and configuration of a computational entity, the method comprising:
providing a machine-learning-based policy evaluator comprising
computer instructions that, when executed by one or more processors of a computer system including the one or more processors and one or more memories, at least one of which stores the computer instructions, control the computer system to
receive a specification, an initial policy, and a target policy,
optionally receive a runtime state, and
output a policy-change favorability indication,
a machine-learning-based performance estimator that produces an estimate of the performance of a computational entity based on learned workload characteristics, corresponding to the received specification, controlled by the target policy, and
a policy-change-favorability-indication generator that uses the performance estimate produced by the machine-learning-based performance estimator to generate the policy-change favorability indication output by the machine-learning-based policy evaluator; and
employing an optimization method that generates the policy by
generating a first policy, and
iteratively
generating a candidate policy,
evaluating the candidate policy relative to the first policy using the machine-learning-based policy evaluator,
when the policy-change favorability indication output by the machine-learning-based policy evaluator indicates that the candidate policy would result in operational characteristics of the computational entity closer to specified operational characteristics that the operational characteristics produced by the first policy, the replacing the first policy with the candidate policy; and
outputting the first policy as the new policy.

16. The method of claim 14
wherein the new policy, first policy, candidate policy, initial policy, and target policy each comprises one or more policy components that together specify resource allocation, configuration, and deployment of a computational entity to a distributed computer system;
wherein computational entities include distributed applications, microservices, and distributed-application components.

17. The method of claim 16
wherein the specification received by the machine-learning-based policy evaluator includes configuration and deployment specifications and target operational characteristics;
wherein the specification received by the machine-learning-based policy evaluator includes one or more of
workload characteristics, and
information from which workload characteristics can be derived; and
wherein the runtime state optionally received by the machine-learning-based policy evaluator includes indications of runtime-state factors, including:
computational-entity performance;
resource capacities; and
resource availabilities.

18. The method of claim 17 wherein the policy-change-favorability-indication generator generates the policy-change favorability indication output by:
estimating a policy-transition cost using a specified configuration derived from the received specification, initial policy, and target policy;
estimating changes in non-performance runtime-state factor values resulting from a transition from the initial policy to the target policy;
receiving a performance estimate from machine-learning-based performance estimator;
when a runtime state is received by the machine-learning-based policy evaluator,
extracting an initial performance from the received runtime state;
when a runtime state is not received by the machine-learning-based policy evaluator,
computing an initial performance from the received specification and initial policy;
computing a change in the performance runtime-state-factor value using the received performance estimate and the initial performance; and
using the policy-transition cost, estimated changes in non-performance runtime-state factor values, and computed change in the performance runtime-state-factor value to generate the policy-change favorability indication.

19. The method of claim 18
wherein the policy-change favorability indication is a signed numerical value;
wherein, when the policy-change favorability indication is positive, the policy-change favorability indication indicates that a policy transition from the initial policy to the target policy would result in a runtime state associated with operational characteristics closer to the target operational characteristics:
wherein, when the policy-change favorability indication is negative, the policy-change favorability indication indicates that a policy transition from the initial policy to the target policy would result in a runtime state associated with operational characteristics that differ more from the target operational characteristics; and
wherein the magnitude of the policy-change favorability indication indicates the magnitudes of the predicted changes in the operational characteristics associated with the resulting runtime state.

20. The machine-learning-based policy evaluator of claim 5
wherein the machine-learning-based performance estimator is a conditional variational autoencoder; and
wherein, during operation of the machine-learning-based policy evaluator
an encoder portion of the conditional variational autoencoder receives a computed or derived initial performance value and a label comprising a specified configuration and the initial policy;
a decoder portion of the conditional variational autoencoder receives an encoding of the initial performance output by the encoder portion of the conditional variational autoencoder and a label comprising the specified configuration and the target policy; and
the decoder portion of the conditional variational autoencoder outputs an estimated performance value following a policy transition from the initial policy to the target policy.

21. A data-storage device containing computer instructions that, when executed by a computer system, control the computer system to provide a machine-learning-based based performance estimator that receives an encoded performance for a computational entity, an encoded configuration specification for the computational entity, an initial policy for controlling deployment and configuration of the computational entity, and a target policy and that outputs an encoded estimated performance based on learned workload characteristics, the machine-learning-based policy evaluator implemented by a conditional variational autoencoder comprising:
an encoder layer, comprising one or more neural-network-node layers, that receives the encoded performance and outputs a vector corresponding to a latent-space point;
a hidden layer comprising one or more neural-network-node layers that receives the vector corresponding to a latent-space point and outputs the vector to a decoder layer; and
the decoder layer comprising one or more neural-network-node layers that receives the vector corresponding to a latent-space point and outputs the encoded estimated performance.
